(19) United States
(12) Patent Application Publication
(10) Pub. No.: US 2012/0147165 A1
(43) Pub. Date: Jun. 14, 2012

(54) CONTROL DEVICE, ENDOSCOPE APPARATUS, AND FOCUS CONTROL METHOD

(75) Inventors: Koichiro YOSHINO, Tokyo (JP); Jumpei TAKAHASHI, Tokyo (JP); Yasunori MORITA, Tokyo (JP)

(73) Assignee: OLYMPUS CORPORATION, Tokyo (JP)

(21) Appl. No.: 13/315,727

(22) Filed: Dec. 9, 2011

(30) Foreign Application Priority Data
Dec. 13, 2010 (JP) 2010-277079

(51) Int. Cl. H04N 5/232; H04N 7/18

(52) U.S. Cl. 348/65; 348/345; 348/E05.045; 348/E07.085

(57) ABSTRACT

A control device includes an image acquisition section and a focus control section. The image acquisition section acquires an image captured by an imaging section. The focus control section performs a focus control process that focuses the imaging section on an object based on the acquired image. The focus control section performs the focus control process based on an image for which occurrence of a bright spot is suppressed.

Japanese Patent Application No. 2010-277079 filed on Dec. 13, 2010, is hereby incorporated by reference in its entirety.

### BACKGROUND

The present invention relates to a control device, an endoscope apparatus, a focus control method, and the like.

An imaging apparatus such as an endoscope is desired to generate a deep-focus image in order to facilitate a doctor's diagnosis. In order to deal with such a demand, the depth of field of an endoscope is increased by utilizing an optical system having a relatively large F-number to implement deep focus.

In recent years, an imaging element having about several hundred thousand pixels has been used for endoscope systems. The depth of field of an imaging apparatus is determined by the size of the permissible circle of confusion for an identical optical system. Since an imaging element having a large number of pixels has a small pixel pitch and a small permissible circle of confusion, the depth of field of the imaging apparatus decreases.

An endoscope apparatus that includes an imaging section and a focus driver section that changes the in-focus object plane position of the objective optical system, and performs an autofocus (AF) process on the object has been proposed (see JP-A-8-106060, for example). In JP-A-8-106060, the contrast value is calculated from a plurality of images acquired while changing the in-focus object plane position, and the focus target position is detected from the calculated contrast value to implement the AF process.

An endoscope has a problem in which illumination light reflected by the surface of the object may enter the imaging element, so that a bright spot may occur. For example, it may be difficult to accurately calculate the contrast value from the image due to a bright spot, so that the accuracy of the AF process may deteriorate.

### SUMMARY

According to one aspect of the invention, there is provided a control device comprising:

an image acquisition section that acquires an image captured by an imaging section; and

a focus control section that performs a focus control process that focuses the imaging section on an object based on the acquired image,

the focus control section performing the focus control process based on an image for which occurrence of a bright spot is suppressed.

According to another aspect of the invention, there is provided a control device comprising:

an image acquisition section that acquires an image captured by an imaging section; and

a focus control section that performs a focus control process that focuses the imaging section on an object based on the acquired image, the focus control section performing the focus control process based on a focus detection image, the focus detection image being captured under an imaging condition that differs from an imaging condition used when capturing a normal image.

According to another aspect of the invention, there is provided a focus control method comprising:

acquiring an image captured by an imaging section;

performing a focus control process that focuses the imaging section on an object based on the acquired image; and

performing the focus control process based on an image for which occurrence of a bright spot is suppressed.

### BRIEF DESCRIPTION OF THE DRAWINGS

FIG. 1 shows a first configuration example of an endoscope system.

FIG. 2 shows a first detailed configuration example of an AF control section.

FIG. 3 shows a setting example of an evaluation area used to calculate a contrast value.

FIG. 4 shows a detailed configuration example of a contrast value calculation section.

FIG. 5 shows a modified configuration example of an AF control section.

FIG. 6 shows a modified configuration example of an endoscope system.

FIG. 7 shows a second modified configuration example of an endoscope system.

FIG. 8 shows a second configuration example of an endoscope system.

FIG. 9 is a view illustrative of a bright spot-suppressing method according to a second embodiment.

FIG. 10 is a view illustrative of the bright spot-suppressing method according to the second embodiment.

FIG. 11 is a view illustrative of the bright spot-suppressing method according to the second embodiment.

FIG. 12 is a view illustrative of the bright spot-suppressing method according to the second embodiment.

FIG. 13 is a view illustrative of the bright spot-suppressing method according to the second embodiment.

FIG. 14 shows a second detailed configuration example of an AF control section.

FIG. 15 is a view illustrative of the bright spot-suppressing method according to the second embodiment.

FIG. 16 is a view illustrative of the bright spot-suppressing method according to the second embodiment.

FIG. 17 shows a third configuration example of an endoscope system.

FIG. 18 is a view illustrative of a bright spot-suppressing method according to a third embodiment.

FIG. 19 is a view illustrative of the bright spot-suppressing method according to the third embodiment.

FIG. 20 is a view illustrative of the bright spot-suppressing method according to the third embodiment.

FIG. 21 is a view illustrative of the bright spot-suppressing method according to the third embodiment.

FIG. 22 shows a third detailed configuration example of an AF control section.

FIG. 23 shows a fourth configuration example of an endoscope system.

FIG. 24 is a view illustrative of a bright spot-suppressing method according to a fourth embodiment.

FIG. 25 is a view illustrative of the bright spot-suppressing method according to the fourth embodiment.

FIG. 26 shows a fourth detailed configuration example of an AF control section.

FIG. 27 shows a fifth detailed configuration example of an AF control section.

FIG. 28 is a view illustrative of a bright spot-suppressing method according to a fifth embodiment.

FIG. 29 is a view illustrative of the bright spot-suppressing method according to the fifth embodiment.

FIG. 30 shows a third modified configuration example of an endoscope system.

FIG. 31 is a view illustrative of a modification of the fifth embodiment.

FIG. 32 shows a sixth detailed configuration example of an AF control section.

FIG. 33 is a view illustrative of a bright spot-suppressing method according to a sixth embodiment.

### DESCRIPTION OF EXEMPLARY EMBODIMENTS

Several aspects of the invention may provide a control device, an endoscope apparatus, a focus control method, and the like that can suppress occurrence of a bright spot.

According to one embodiment of the invention, there is provided a control device comprising:

an image acquisition section that acquires an image captured by an imaging section; and

a focus control section that performs a focus control process that focuses the imaging section on an object based on the acquired image,

the focus control section performing the focus control process based on an image for which occurrence of a bright spot is suppressed.

According to one aspect of the invention, it is possible to focus the imaging section on the object based on an image for which occurrence of a bright spot is suppressed.

Exemplary embodiments of the invention are described below. Note that the following exemplary embodiments do not in any way limit the scope of the invention laid out in the claims. Note also that all of the elements of the following exemplary embodiments should not necessarily be taken as essential elements of the invention.

### 1. Outline

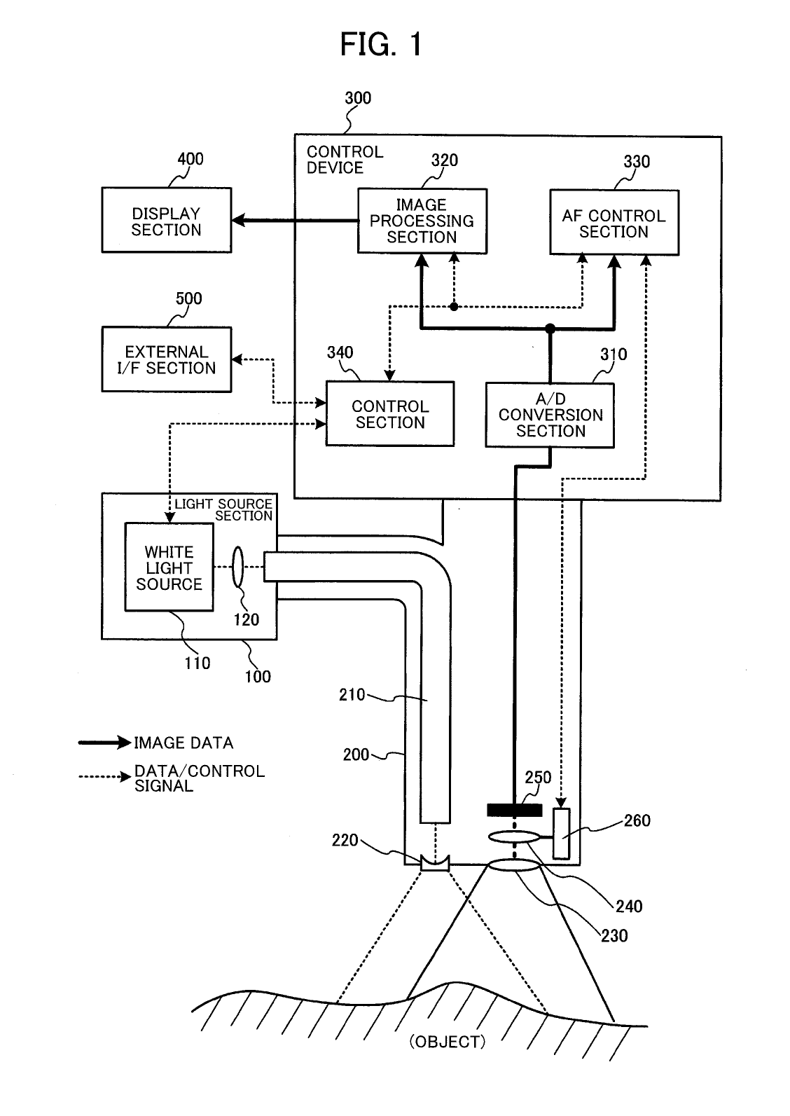

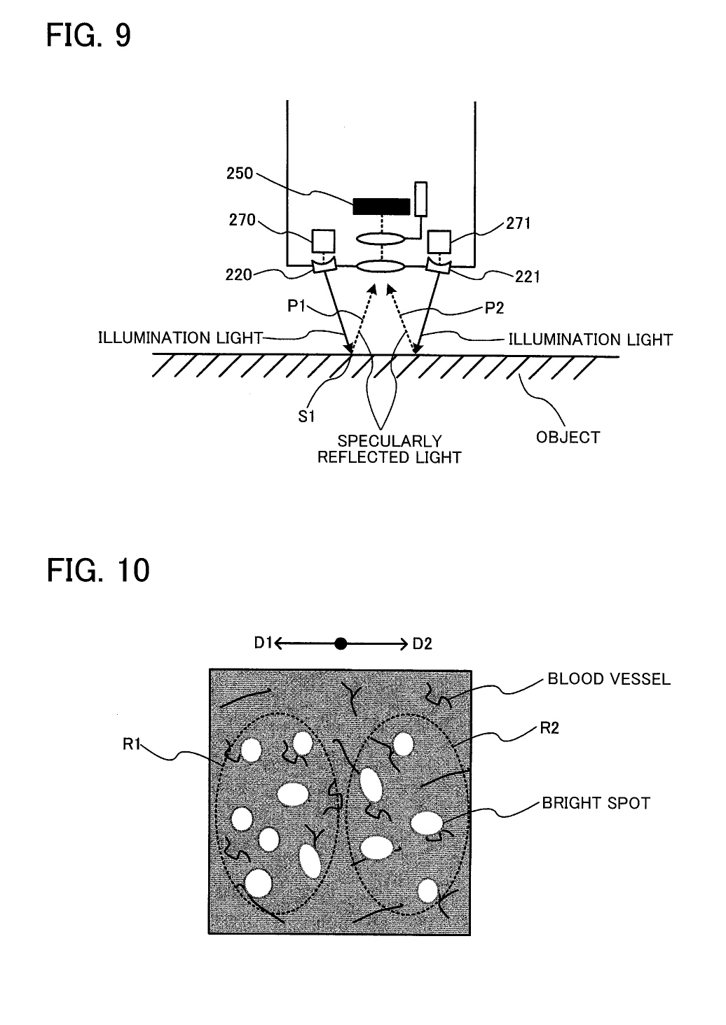

An outline of several embodiments of the invention is described below. As shown in FIG. 1, an endoscope is configured so that an illumination lens 220 that illuminates an object and an objective lens 230 that focuses (collects) reflected light from the object are disposed adjacently. Therefore, the illumination light reflected by the surface of the object may enter the imaging element (see FIG. 9), so that a blown-out highlight area (bright spot) may occur in the image acquired by the endoscope due to pixel saturation.

The contrast value between the bright spot and the peripheral area is significantly larger than the contrast value between a blood vessel and a mucous membrane (i.e., a typical object of the endoscope), for example. Therefore, the contrast value calculated from the image is significantly affected by the bright spot when performing a contrast AF process. Since the number (or area) of bright spots differs between each image due to the motion (movement) of the object or the scope, it may be difficult to stably calculate the contrast value.

According to several embodiments of the invention, the effects of a bright spot on the contrast value is reduced by utilizing an image for which occurrence of a bright spot is suppressed. For example, occurrence of a bright spot is suppressed by reducing the exposure during an AF control process, and the contrast AF process is performed using the resulting image (described later with reference to FIG. 1 and the like). According to several embodiments of the invention, it is also possible to suppress occurrence of a bright spot within the display image or the like. In this case, since an image with a reduced number (or area) of bright spots can be presented to the doctor, the visibility of the object can be improved.

### 2. First Embodiment

### 2.1. Endoscope System

FIG. 1 shows a first configuration example of an endoscope system (endoscope apparatus). The endoscope system includes a light source section 100, an imaging section 200, a control device 300 (processing section), a display section 400, and an external I/F section 500.

The light source section 100 generates illumination light that is applied to the object. The light source section 100 includes a white light source 110 that emits white light, and a condenser lens 120 that focuses the white light on a light guide fiber 210.

The imaging section 200 images the object. The imaging section 200 is formed to be elongated and flexible (i.e., can be curved) so that the imaging section 200 can be inserted into a body cavity or the like. The imaging section 200 includes the light guide fiber 210 that guides light focused by the light source section, an illumination lens 220 that diffuses light that has been guided by the light guide fiber 210, and illuminates the observation target, and an objective lens 230 that focuses light reflected by the observation target. The imaging section 200 also includes a focus adjustment lens 240 that adjusts the in-focus object plane position, a focus driver section 260 that drives the focus adjustment lens 240, and an imaging element 250 that detects the focused reflected light.

The focus driver section 260 is a stepping motor or the like, and is connected to the focus adjustment lens 240. The focus driver section 260 adjusts the in-focus object plane position by changing the position of the focus adjustment lens 240. The imaging element 250 includes a Bayer color filter array, for example. The position of the focus adjustment lens 240 is indicated by the distance from the imaging element 250 to the focus adjustment lens 240 along the optical axis, for example. The term “in-focus object plane position” used herein refers to the position of the object at which the object is in focus, and is indicated by the distance from the objective lens 230 to the in-focus object plane.

The control device 300 controls each element of the endoscope system, and performs image processing and the like. The control device 300 includes an A/D conversion section 310, an image processing section 320, an AF control section 330, and a control section 340.

The A/D conversion section 310 converts an analog signal output from the imaging element 250 into a digital signal, and outputs the digital signal to the image processing section 320 and the AF control section 330. The image processing section 320 performs image processing (e.g., white balance process, interpolation process (demosaicing process), color conversion process, and grayscale conversion process) on the digital signal output from the AD conversion section 310, and outputs the resulting image to the display section 400. The control section 340 is bidirectionally connected to the white light source 110, the image processing section 320, the AF control section 330, and the external I/F section 500, and controls the white light source 110, the image processing section 320, the AF control section 330, and the external I/F section 500 based on information input from the external I/F section 500. The AF control section 330 performs an AF control process based on the captured image.

The display section 400 is a liquid crystal monitor or the like, and displays the image output from the image processing section 320. The external I/F section 500 is an interface that allows the user to input information to the endoscope system, for example. The external I/F section 500 includes a start button (imaging start/stop button), an AF switch button (AF start/stop button), an imaging condition adjustment button, and the like.

The control section 340 adjusts the exposure used when capturing an image by controlling the intensity of light emitted from the white light source 110 based on exposure information (first exposure) input from the external I/F section 500, for example. The control section 340 outputs AF start/stop information included in the information input from the external I/F section 500 to the AF control section 330. Note that the AF process need not necessarily be performed when the AF switch button has been operated. For example, the AF process may be performed at given intervals, or a continuous AF process may be performed.

### 2.2. AF Control Section

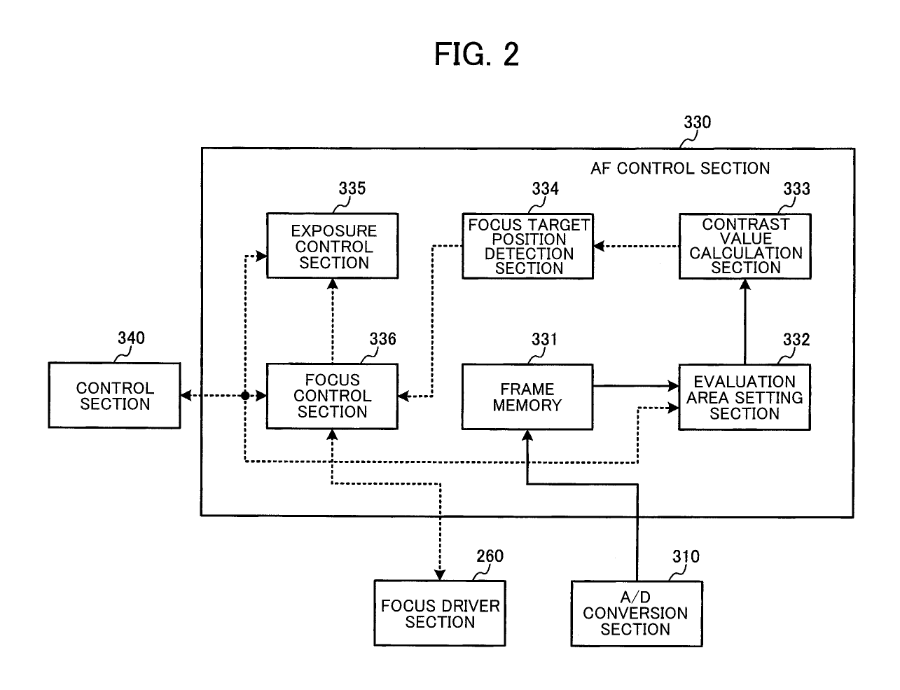

FIG. 2 shows a first detailed configuration example of the AF control section 330. The AF control section 330 includes a frame memory 331, an evaluation area setting section 332, a contrast value calculation section 333 (evaluation value calculation section), a focus target position detection section 334, an exposure control section 335, and a focus control section 336.

The focus control section 336 is bidirectionally connected to the control section 340. The focus control section 336 starts the AF process when the focus control section 336 has received the AF start information from the control section 340. Specifically, the focus control section 336 outputs in-focus object plane position information to the focus driver section 260. The focus driver section 260 changes the position of the focus adjustment lens 240 based on the in-focus object plane position information output from the focus control section 336. An image is captured by the imaging element 250 at the in-focus object plane position indicated by the in-focus object plane position information output from the focus control section 336, converted into a digital signal by the A/D conversion section 310, and stored in the frame memory 331.

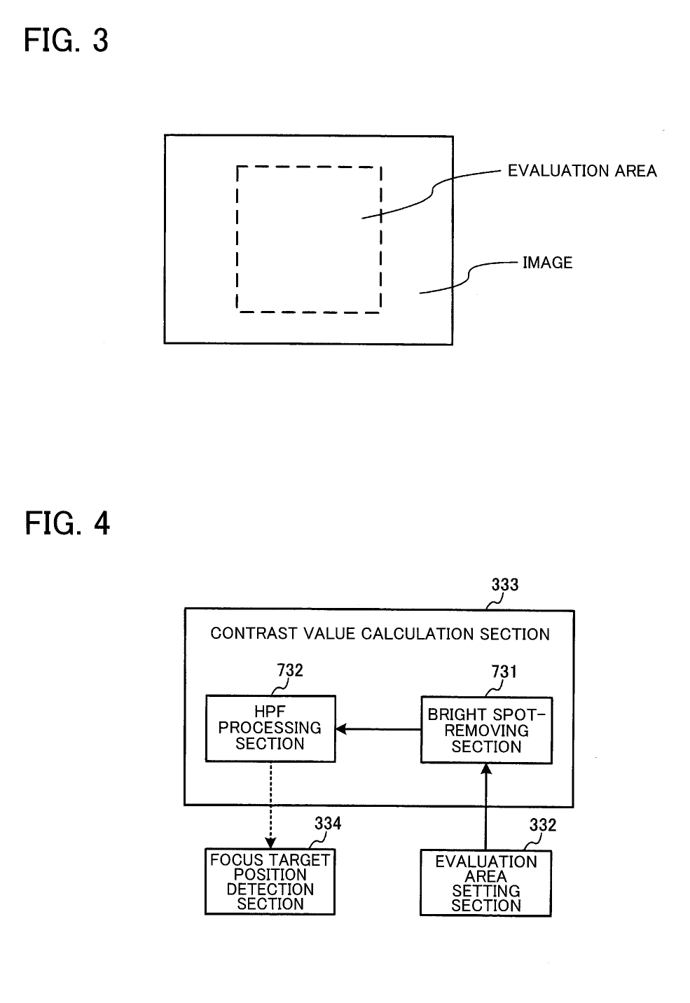

The evaluation area setting section 332 sets an evaluation area used to calculate the contrast value (evaluation value) within the image stored in the frame memory 331. For example, an area set in advance may be set as the evaluation area (see FIG. 3), or the user may input information about the evaluation area via the external I/F section 500, and an arbitrary evaluation area may be set within the image based on the input information. The evaluation area setting section 332 outputs evaluation area information about the set evaluation area and the image to the contrast value calculation section 333.

The contrast value calculation section 333 calculates the contrast value of the evaluation area based on the evaluation area information and the image. For example, when the image output from the evaluation area setting section 332 is a Bayer array image, the contrast value calculation section 333 performs a known demosaicing process so that each pixel of the image has 3-channel (RGB) pixel values, and calculates the contrast value using an arbitrary channel. The contrast value calculation section 333 may generate a luminance signal from the 3-channel (RGB) pixel values, and calculate the contrast value using the pixel value of the generated luminance signal. The contrast value calculation section 333 outputs the contrast value of the evaluation area to the focus target detection section 334.

FIG. 4 shows a detailed configuration example of the contrast value calculation section 333. The contrast value calculation section 333 includes a bright spot-removing section 731 and an HPF processing section 732. Note that the configuration of the contrast value calculation section 333 is not limited to the configuration shown in FIG. 4. For example, the contrast value calculation section 333 may not include the bright spot-removing section 731.

The HPF processing section 732 performs a high-pass filter (HPF) process on the evaluation area. For example, the HPF processing section 732 performs an arbitrary HPF process on each pixel included in the evaluation area, and calculates the contrast value by summing up the HPF output value of each pixel.

The bright spot-removing section 731 removes a bright spot included in the evaluation area. For example, the bright spot-removing section 731 performs a threshold process on an arbitrary channel of each pixel included in the evaluation area or the pixel value of the luminance signal. The bright spot-removing section 731 determines that the pixel is a bright spot when the pixel value is equal to or larger than the threshold value, and outputs information (e.g., coordinates) about the pixel that has been determined to be a bright spot to the HPF processing section 732. The HPF processing section 732 sets the HPF output value of the pixel that has been determined to be a bright spot to “0”. Therefore, since the HPF output value of the pixel that has been determined to be a bright spot is not added to the contrast value, the effect of the bright spot on the contrast value can be reduced.

The focus target detection section 334 detects the focus target position based on the contrast value calculated by the contrast value calculation section 333. The term “focus target position” used herein refers to the position at which the object of focus target is considered to be in focus.

The details of the AF control process are described below. The focus control section 336 sequentially outputs in-focus object plane position information that indicates an in-focus object plane position that is slightly changed to the focus driver section 260. The contrast value calculation section 333 calculates the contrast value based on an image captured at each in-focus object plane position, and sequentially outputs the contrast value at each in-focus object plane position to the focus target detection section 334.

The focus target detection section 334 detects the focus target position using the contrast information sequentially output from the contrast value calculation section 333 by utilizing a known AF method (e.g., hill-climbing method). Specifically, the focus target detection section 334 determines the in-focus object plane position at which the contrast value becomes a maximum to be the focus target position. The focus target detection section 334 outputs focus target position information that indicates the detected focus target position to the focus control section 336.

The focus control section 336 outputs the focus target position information to the focus driver section 260. The focus driver section 260 moves the position of the focus adjustment lens 240 based on the focus target position information. When the focus control section 336 has confirmed that the focus adjustment lens 240 has moved to the position at which the focus target position is achieved, the focus control section 336 stops the AF process.

A method that stably calculates the contrast value is described below. When the focus control section 336 has received the AF start information from the control section 340, the focus control section 336 outputs exposure control start information to the exposure control section 335. The exposure control section 335 generates exposure information (second exposure) used to calculate the contrast value based on the exposure control start information, and outputs the exposure information to the control section 340.

When the exposure information is output from the exposure control section 335, the control section 340 controls the intensity of light emitted from the white light source 110 based on the exposure information. Specifically, the exposure control section 335 sets the second exposure to a value smaller than the first exposure. Therefore, the exposure used when capturing the image used to calculate the contrast value during the AF process is made smaller than the exposure used when capturing the image acquired before starting the AF process. This makes it possible to reduce occurrence of a bright spot within the image used to calculate the contrast value, and stably calculate the contrast value.

The focus control section 336 outputs exposure control end information to the exposure control section 335 when the AF process has ended. The exposure control section 335 stops outputting the exposure information used to calculate the contrast value based on the exposure control end information. When the exposure control section 335 has stopped outputting the exposure information (second exposure), the control section 340 controls the intensity of light emitted from the white light source 110 based on the exposure information (first exposure) input from the external I/F section 500.

### 2.3. Modifications

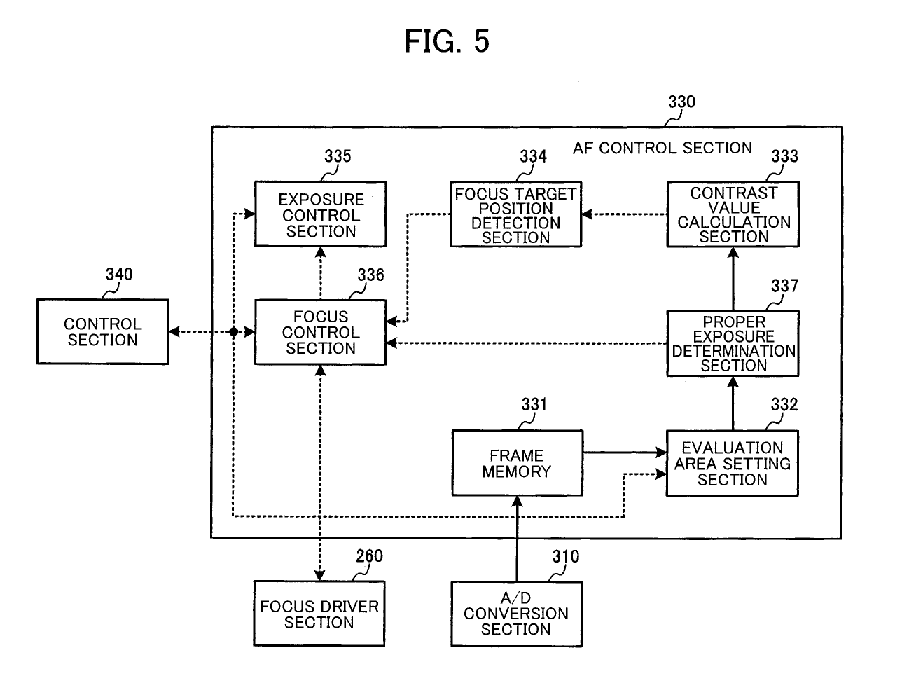

A first modification of the first embodiment is described below. FIG. 5 shows a modified configuration example of the AF control section 330. The AF control section 330 includes a frame memory 331, an evaluation area setting section 332, a contrast value calculation section 333, a focus target detection section 334, an exposure control section 335, a focus control section 336, and a proper exposure determination section 337. Note that the same elements as those described above are indicated by the same symbols. Description of these elements is appropriately omitted.

The proper exposure determination section 337 calculates the exposure in the evaluation area from the evaluation area information and the image output from the evaluation area setting section 332. The image output from the evaluation area setting section 332 is a Bayer array image, for example. In this case, the proper exposure determination section 337 performs a known demosaicing process so that each pixel of the image has 3-channel (RGB) pixel values, and calculates the average pixel value of an arbitrary channel to calculate the exposure. The proper exposure determination section 337 may generate a luminance signal from the 3-channel (RGB) pixel values, and calculate the exposure using the pixel value of the generated luminance signal.

The proper exposure determination section 337 performs a threshold process on the calculated exposure using a proper exposure to determine whether or not the exposure is proper. For example, an upper-limit value and a lower-limit value are set in advance as the proper exposure, and the proper exposure determination section 337 determines that the exposure is proper when the exposure is within the range between the upper-limit value and the lower-limit value. The term “proper exposure” used herein refers to an exposure that is suitable for calculating the contrast value, or an exposure that is suitable for suppressing a bright spot, for example.

When the proper exposure determination section 337 has determined that the exposure is proper, the proper exposure determination section 337 outputs identification information that indicates “proper exposure” to the focus control section 336, and outputs the image to the contrast value calculation section 333, the evaluation area information being added to the image. In this case, the proper exposure determination section 337 outputs the image that has been subjected to the demosaicing process, or a luminance signal image generated from the image that has been subjected to the demosaicing process, to the contrast value calculation section 333. The contrast value calculation section 333 calculates the contrast value of the image output from the proper exposure determination section 337 in the same manner as described above.

When the proper exposure determination section 337 has determined that the exposure is not proper, the proper exposure determination section 337 outputs identification information that indicates “overexposure” or “underexposure” to the focus control section 336. Specifically, the proper exposure determination section 337 outputs the identification information that indicates “overexposure” when the exposure is larger than the upper-limit value of the proper exposure, and outputs the identification information that indicates “underexposure” when the exposure is smaller than the lower-limit value of the proper exposure. When the proper exposure determination section 337 has determined that the exposure is not proper, the proper exposure determination section 337 does not output the image to the contrast value calculation section 333.

When the proper exposure determination section 337 has output the identification information that indicates “overexposure” or “underexposure” to the focus control section 336, the focus control section 336 outputs the same in-focus object plane position information to the focus driver section 260, and outputs exposure correction information to the exposure control section 335. The exposure control section 335 corrects the exposure information (second exposure) used to calculate the contrast value based on the exposure correction information, and outputs the corrected exposure information to the control section 340. Specifically, the focus control section 336 outputs the exposure correction information that decreases the second exposure when the focus control section 336 has received the identification information that indicates “overexposure”, and outputs the exposure correction information that increases the second exposure when the focus control section 336 has received the identification information that indicates “underexposure”.

According to the first modification, when it has been determined that the exposure used when capturing the acquired image is not proper, an image can be acquired again at the same in-focus object plane position using the corrected exposure. This makes it possible for the contrast value calculation section 333 to calculate the contrast value based on a proper exposure image for which occurrence of a bright spot is suppressed. Therefore, the contrast value can be stably calculated. Moreover, a deterioration in S/N ratio due to a decrease in exposure can be suppressed by setting the proper exposure lower-limit value, so that the effects of noise on the contrast value can be reduced.

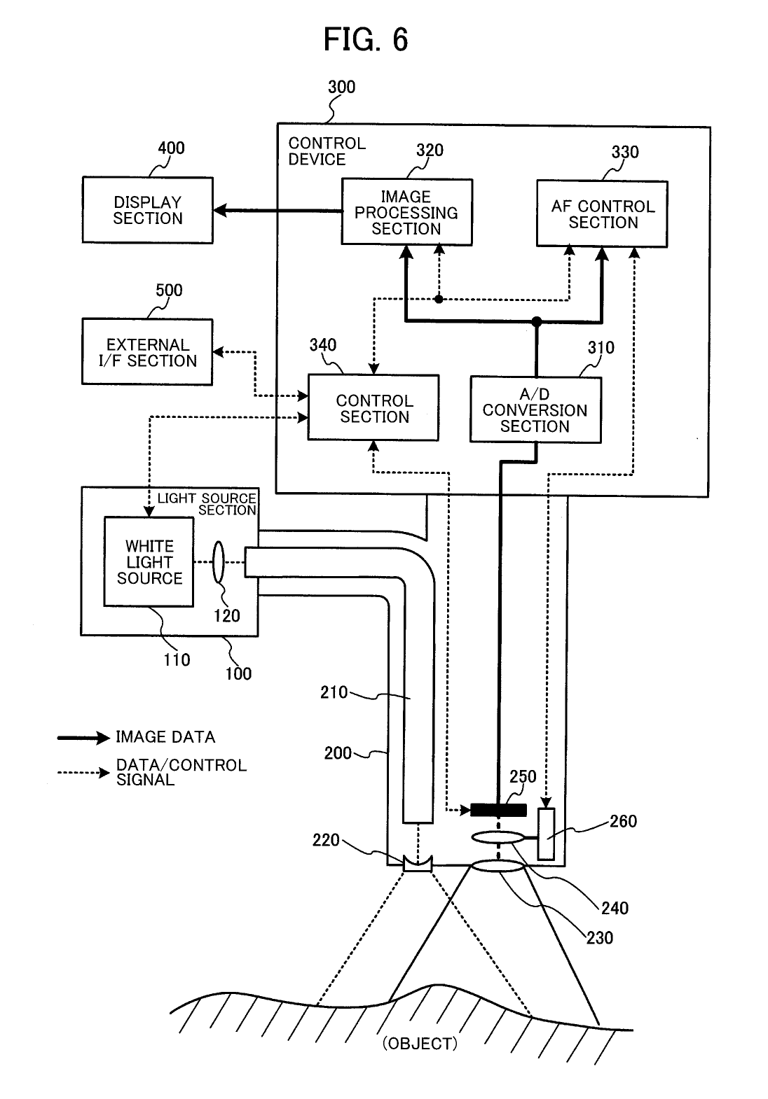

A second modification of the first embodiment is described below. FIG. 6 shows a modified configuration example of the endoscope system. The endoscope system includes the light source section 100, the imaging section 200, the control device 300, the display section 400, and the external I/F section 500. In the second modification, the control section 340 is bidirectionally connected to the imaging element 250.

The exposure control section 335 controls the exposure used when capturing an image by changing the exposure time when the imaging element 250 captures an image instead of the intensity of light emitted from the white light source 110. For example, the exposure control section 335 controls the exposure used when capturing an image by changing the speed of an electronic shutter when the imaging element 250 captures an image. In this case, the exposure control section 335 sets the exposure time corresponding to the second exposure to be shorter than the exposure time corresponding to the first exposure, and the AF process is performed in the same manner as described above. The exposure used when capturing the image used to calculate the contrast value during the AF process can thus be made smaller than the exposure used when capturing the image acquired before starting the AF process.

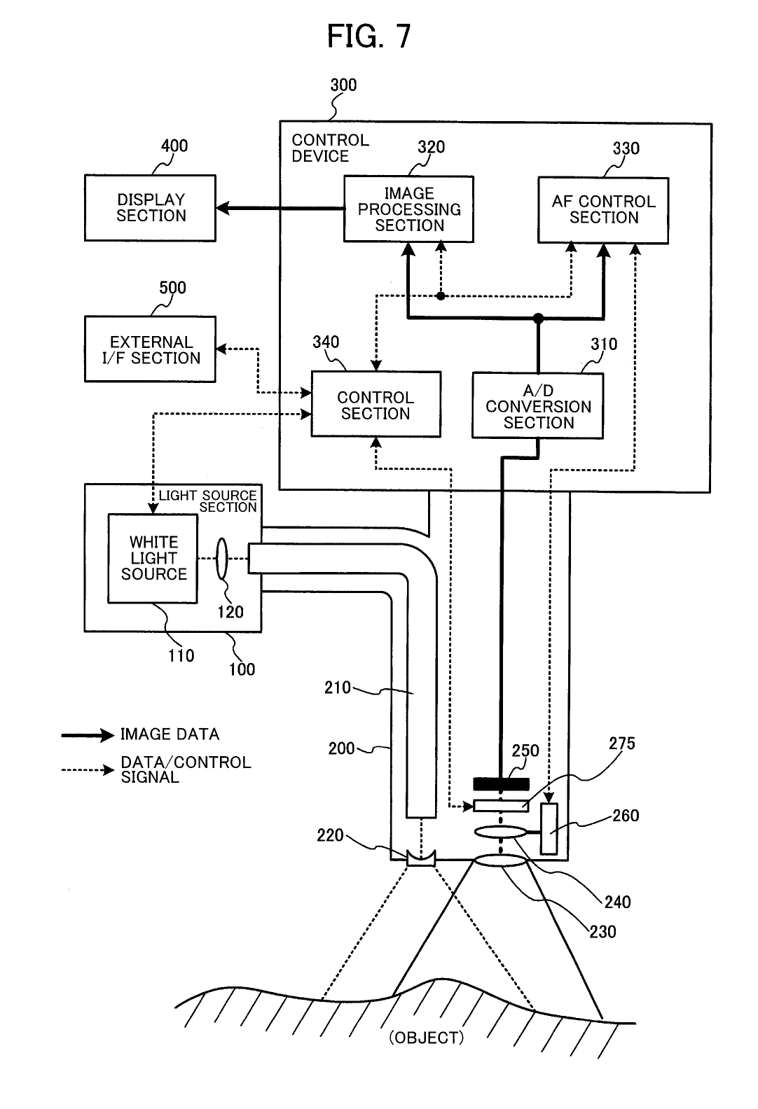

A third modification of the first embodiment is described below. FIG. 7 shows a second modified configuration example of the endoscope system. The endoscope system includes the light source section 100, the imaging section 200, the control device 300, the display section 400, and the external I/F section 500. In the third modification, the imaging section 200 further includes a transmittance adjustment section 275 that can be changed in transmittance corresponding to a control signal.

The transmittance adjustment section 275 includes a liquid crystal shutter or a variable aperture that can be changed in aperture diameter, for example. The transmittance adjustment section 275 is provided between the objective lens 230 and the imaging element 250, and is bidirectionally connected to the control section 340.

The exposure control section 335 controls the exposure used when capturing an image by changing the transmittance of the transmittance adjustment section 275 instead of the intensity of light emitted from the white light source 110. In this case, the exposure control section 335 sets the transmittance corresponding to the second exposure to be lower than the transmittance corresponding to the first exposure, and the AF process is performed in the same manner as described above. The exposure used when capturing the image used to calculate the contrast value during the AF process can thus be made smaller than the exposure used when capturing the image acquired before starting the AF process.

The focusing accuracy of the AF process deteriorates due to a bright spot. Specifically, the contrast value of an endoscope changes due to a change in occurrence state of a bright spot caused by the movement (motion) of the digestive tract or the like.

The control device 300 according to the first embodiment includes an image acquisition section (e.g., A/D conversion section 310) that acquires an image captured by the imaging section 200, and a focus control section (AF control section 330) that performs a focus control process that focuses the imaging section 200 on an object based on the acquired image. The focus control section performs the focus control process based on an image for which occurrence of a bright spot is suppressed.

According to the control device 300, since the contrast value can be calculated from an image for which occurrence of a bright spot is suppressed, the effects of a bright spot on the contrast value can be reduced. This makes it possible to accurately focus the imaging section on the object even if the occurrence state of a bright spot changes.

The term “bright spot” used herein refers to a pixel having a pixel value (e.g., luminance) that has been saturated (e.g., has become equal to or larger than a threshold value). For example, the bright spot is a glare that occurs due to specular (regular) reflection of illumination light by the surface of the object. The bright spot may be a highlight that occurs due to illumination light.

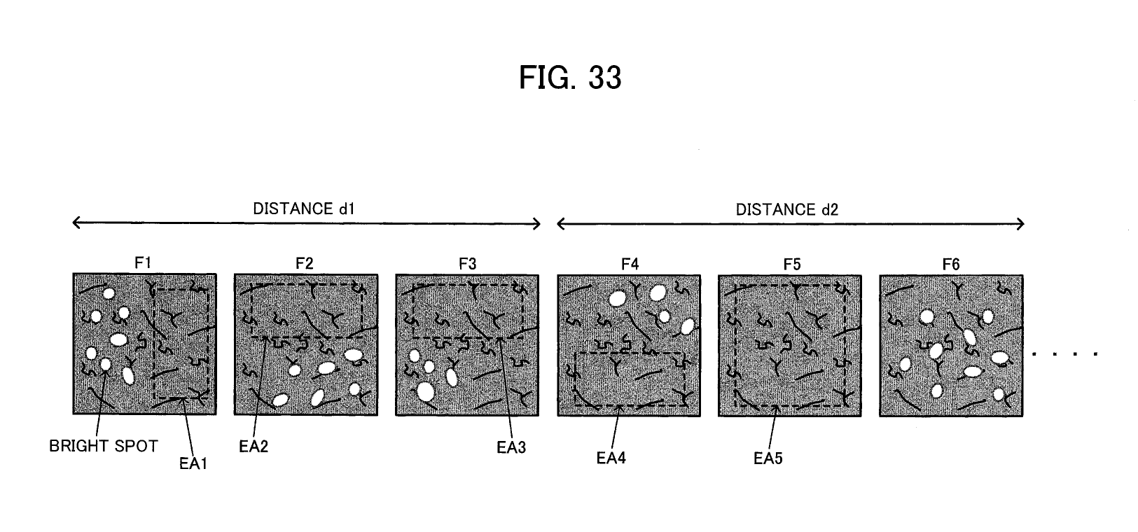

The term “image for which occurrence of a bright spot is suppressed” used herein refers to an image for which occurrence of a bright spot is relatively suppressed as compared with another image, or an area of an image for which occurrence of a bright spot is relatively suppressed as compared with the remaining area. For example, the term “image for which occurrence of a bright spot is suppressed” used herein refers to an image for which occurrence of a bright spot is suppressed as compared with an image captured when the AF process is not performed as a result of changing the imaging condition, or an image or an area in which the number of bright spots has decreased as compared with another image or area due to the motion of the object or the like (described later with reference to FIG. 33).

The focus control section may perform the focus control process using a focus detection image as the image for which occurrence of a bright spot is suppressed, the focus detection image being an image used for focus detection and being captured under an imaging condition that differs from an imaging condition used when capturing a normal image.

This makes it possible to acquire the focus detection image for which occurrence of a bright spot is suppressed by changing the imaging condition, calculate the contrast value of the focus detection image, and perform the AF control process.

The term “normal image” used herein refers to an image that is captured when the AF control process is not performed (e.g., an image that is displayed on the display section). The term “imaging condition” used herein refers to a setting, a situation (status), or the like when capturing an image. Examples of the imaging condition include the F-number, the exposure time, the imaging sensitivity, the intensity of illumination light, the irradiation time of illumination light, the presence or absence of irradiation of illumination light, the emission direction of illumination light, the presence or absence of polarization, the frame rate, and the like. The term “focus detection image” used herein refers to an image that is captured for the AF control process, or an image positioned within the evaluation area that is set within the captured image.

The imaging condition may be the exposure. As shown in FIG. 2, the focus control section may include the exposure control section 335 that sets the exposure used when capturing the focus detection image to be smaller than the exposure used when capturing the normal image.

Specifically, the exposure control section 335 may control the exposure by controlling the intensity of illumination light that illuminates the object. The exposure control section 335 may set the intensity used when capturing the focus detection image to be lower than the intensity used when capturing the normal image.

As shown in FIG. 6, the exposure control section 335 may control the exposure by controlling the exposure time when the imaging section 200 captures an image. In this case, the exposure control section 335 may set the exposure time used when capturing the focus detection image to be shorter than the exposure time used when capturing the normal image.

As shown in FIG. 7, the exposure control section 335 may control the exposure by controlling the transmittance of an objective optical system that is included in the imaging section 200. In this case, the exposure control section 335 may set the transmittance when capturing the focus detection image to be lower than the transmittance when capturing the normal image.

It is possible to suppress occurrence of a bright spot within the focus detection image by thus changing the exposure during the AF control process. The area and the number of bright spots can be reduced by reducing the intensity of illumination light, the exposure time, or the transmittance of the objective optical system.

Note that the transmittance of the objective optical system refers to the ratio of the intensity of emitted light to the intensity of light that enters the objective optical system. The transmittance may be adjusted using a liquid crystal shutter, an aperture, or the like.

The focus control section may include the contrast value calculation section 333 that calculates the contrast value of the evaluation area that is set within the acquired image. The focus control section performs the focus control process based on the calculated contrast value.

This makes it possible to calculate the contrast value of the evaluation area, and perform the focus control process based on the contrast value. For example, the AF control process can be performed by the hill-climbing method. Note that the contrast value refers to an evaluation value for evaluating the degree of in-focus of the object. For example, the contrast value is calculated by extracting a high-frequency component of the image.

As shown in FIG. 4, the contrast value calculation section 333 may determine whether or not each of a plurality of pixels included in the evaluation area is a bright spot, and may calculate the contrast value based on pixels among the plurality of pixels other than a pixel that has been determined to be the bright spot.

This makes it possible to prevent a situation in which the contrast value is affected by a bright spot that has not been removed by changing the imaging condition or the like.

As shown in FIG. 5, the focus control section may include the proper exposure determination section 337 that determines whether or not the evaluation area is subjected to proper exposure. The focus control section may perform the focus control process when the proper exposure determination section 337 has determined that the evaluation area is subjected to proper exposure.

This makes it possible to perform the AF process using an exposure that is suitable for calculating the contrast value. For example, an exposure that is suitable for suppressing occurrence of a bright spot can be achieved by setting the proper exposure upper limit. An excessive decrease in contrast value due to a dark image, or the effects of noise can be suppressed by setting the proper exposure lower limit.

### 3. Second Embodiment

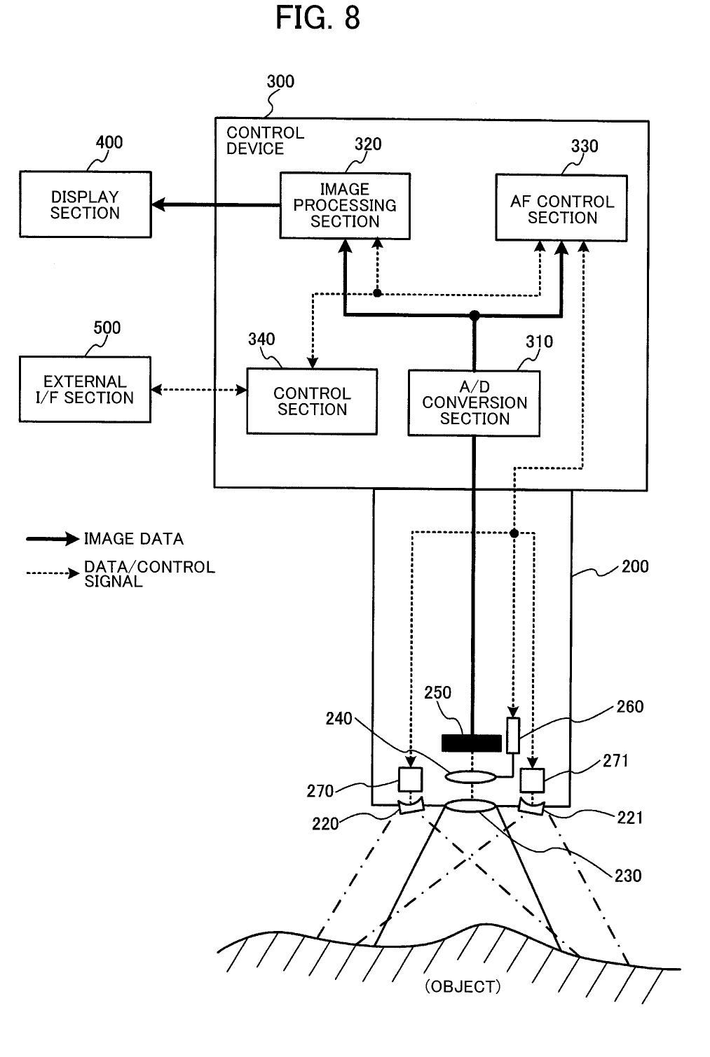

A second embodiment of the invention is described below. In the second embodiment, occurrence of a bright spot is suppressed by changing the emission position of illumination light. FIG. 8 shows a second configuration example of an endoscope system. The endoscope system includes an imaging section 200, a control device 300, a display section 400, and an external I/F section 500. Note that description of the same elements as those described above in connection with the first embodiment is appropriately omitted.

The imaging section 200 includes an LED or the like. The imaging section 200 includes two white light sources 270 and 271 (a plurality of white light sources in a broad sense) that emit white light. The imaging section 200 also includes illumination lenses 220 and 221 that focus white light, and apply the focused white light to the observation target, an objective lens 230 that focuses light reflected by the observation target, a focus adjustment lens 240 that adjusts the in-focus object plane position, an imaging element 250 that detects the focused reflected light, and a focus driver section 260 that drives the focus adjustment lens 240.

A method according to the second embodiment that stably calculates the contrast value is described below. As shown in FIG. 8, the endoscope system is normally configured so that the objective lens 230 is disposed adjacent to the illumination lenses 220 and 221. As shown in FIG. 9, illumination light emitted from the illumination lenses 220 and 221 is specularly reflected by the surface of the object, and specularly reflected light P1 and specularly reflected light P2 from the surface of the object enter the objective lens 230, so that a bright spot occurs within the image.

As a result, a number of bright spots occur within the image captured by the imaging element 250 (see FIG. 10). A bright spot that has occurred due to the specularly reflected light P1 is included in an area R1 shown in FIG. 10, and a bright spot that has occurred due to the specularly reflected light P2 is included in an area R2 shown in FIG. 10. The specularly reflected light P1 is reflected light that has occurred due to the illumination light emitted through the illumination lens 220 and the specularly reflected light P2 is reflected light that has occurred due to the illumination light emitted through the illumination lens 221.

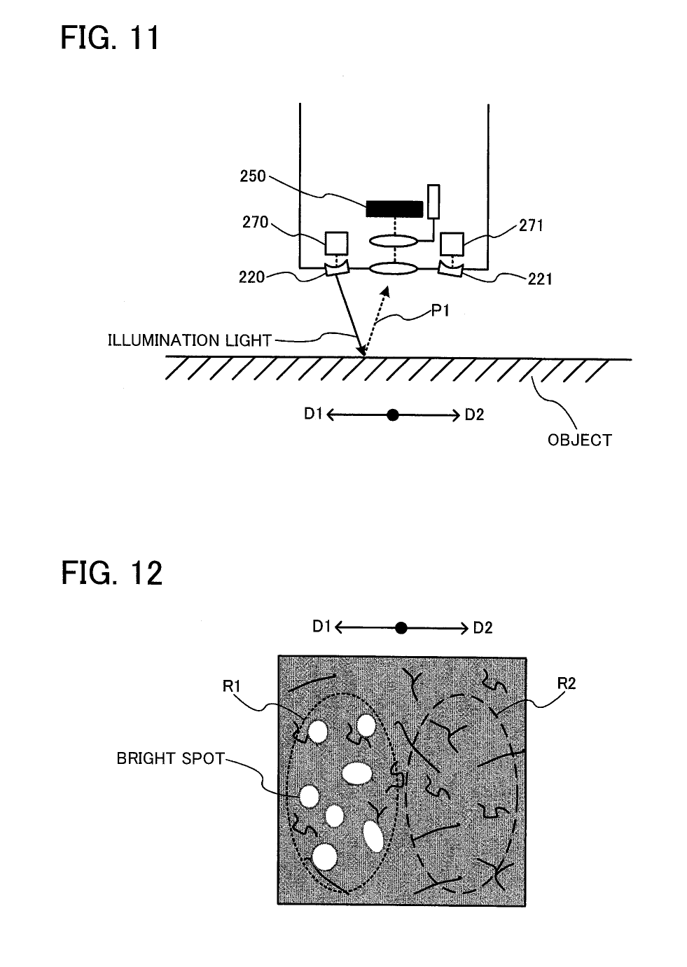

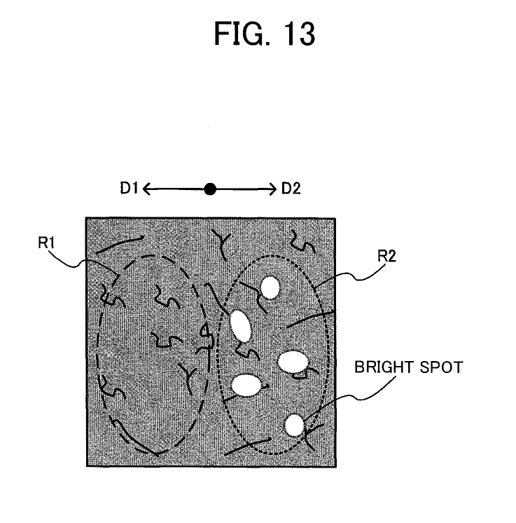

The state of bright spots that occur within the image significantly changes depending on the illumination conditions for the illumination light emitted through the illumination lenses 220 and 221. For example, when causing only the white light source 270 to emit illumination light, illumination light is not emitted through the illumination lens 221. In this case, only the specularly reflected light P1 enters the imaging element 250 as specularly reflected light (see FIG. 11). Therefore, occurrence of a bright spot within the area R2 is suppressed (see FIG. 12), and an image in which the number of bright spots is smaller than that of the image shown in FIG. 10 is acquired. When causing only the white light source 271 to emit illumination light, occurrence of a bright spot within the area R1 is suppressed (see FIG. 13), and an image in which the number of bright spots is smaller than that of the image shown in FIG. 10 is acquired.

An image for which occurrence of a bright spot is suppressed as compared with the case of causing each white light source to emit illumination light can be acquired by thus acquiring an image while selectively causing the white light source 270 or 271 to emit illumination light.

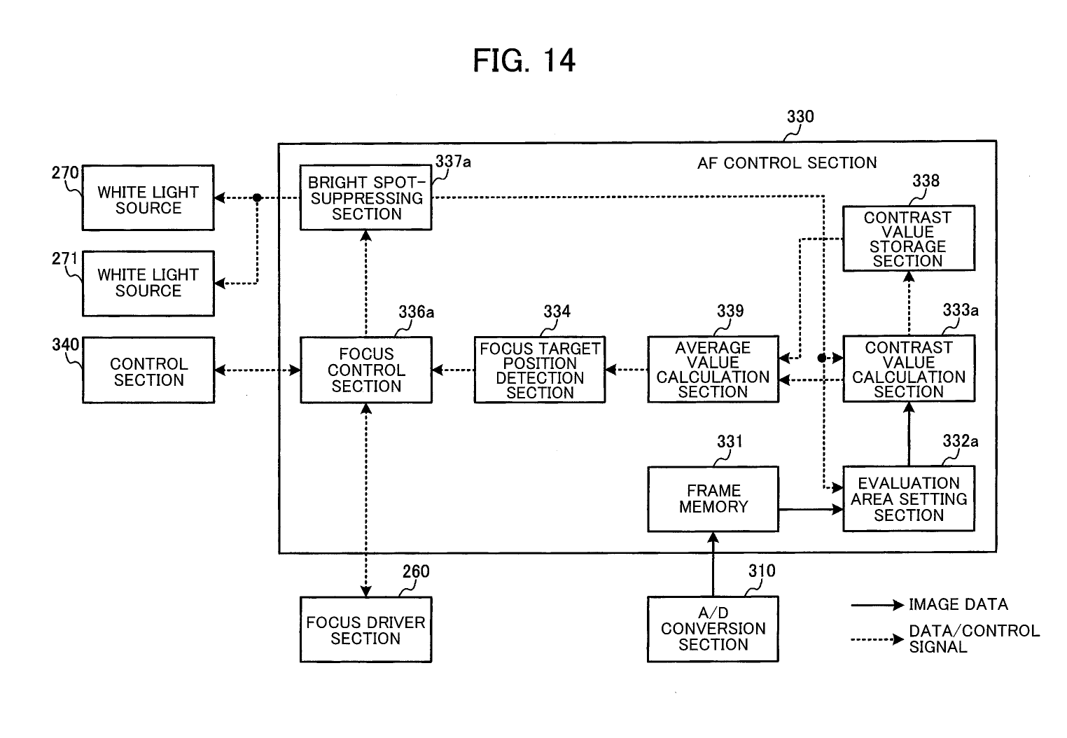

FIG. 14 shows a second detailed configuration example of the AF control section 330. The AF control section 330 includes a frame memory 331, an evaluation area setting section 332a, a contrast value calculation section 333a, a focus target detection section 334, a focus control section 336a, a bright spot-suppressing section 337a, a contrast value storage section 338, and an average value calculation section 339. The configuration of the frame memory 331 and the process performed by the focus target detection section 334 are the same as those described above in connection with the first embodiment.

The focus control section 336a is bidirectionally connected to the control section 340. When the focus control section 336a has received AF start information from the control section 340, the focus control section 336a outputs bright spot suppression start information to the bright spot-suppressing section 337a. The focus control section 336a outputs bright spot suppression end information to the bright spot-suppressing section 337a when the AF process has ended.

The bright spot-suppressing section 337a is connected to the white light sources 270 and 271, and causes each white light source to be independently turned ON/OFF. The bright spot-suppressing section 337a controls the white light sources 270 and 271 based on the bright spot suppression start information output from the focus control section 336a. For example, the bright spot-suppressing section 337a sequentially causes only the white light source 270 (hereinafter may be referred to “left single illumination condition”) or only the white light source 271 (hereinafter may be referred to “right single illumination condition”) to be turned ON. The bright spot-suppressing section 337a outputs an identification signal that specifies the current illumination condition to the evaluation area setting section 332a and the contrast value calculation section 333a. For example, the identification signal is set as follows. Note that the white light sources 270 and 271 are turned ON (hereinafter may be referred to “double illumination condition”) when the AF process is not performed (normal observation).

| Illumination condition | Identification signal |
|---|---|
| Left single illumination | 1 |
| Right single illumination | 2 |

The bright spot-suppressing section 337a changes the illumination condition to the double illumination condition when the focus control section 336a has output the bright spot suppression end information, and stops outputting the identification signal. The illumination condition for the white light sources 270 and 271 is thus returned to the illumination condition employed when the AF process is not performed.

The evaluation area setting section 332a sets an evaluation area used to calculate the contrast value within the image stored in the frame memory 331. The evaluation area setting section 332a sets the evaluation area based on the identification signal output from the bright spot-suppressing section 337a.

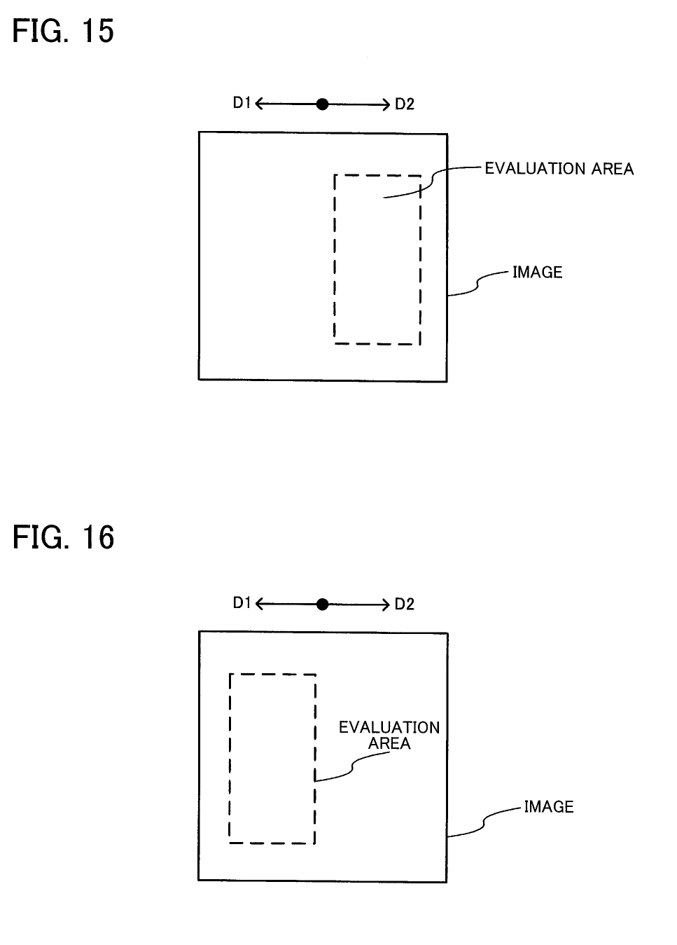

The relationship between the illumination condition and the evaluation area setting method is described below. When the identification signal output from the bright spot-suppressing section 337a is set to “1” (left single illumination condition), the evaluation area setting section 332a sets the evaluation area in the right area of the image (see FIG. 15). This is because the number of bright spots is reduced in the right area of the image under the left single illumination condition (see FIG. 12). When the identification signal output from the bright spot-suppressing section 337a is set to “2” (right single illumination condition), the evaluation area setting section 332a sets the evaluation area in the left area of the image (see FIG. 16). This is because the number of bright spots is reduced in the left area of the image under the right single illumination condition (see FIG. 13).

The contrast value calculation section 333a calculates the contrast value based on the image and evaluation area information output from the evaluation area setting section 332a. The contrast value is calculated in the same manner as in the first embodiment. The contrast value calculation section 333a refers to identification information output from the bright spot-suppressing section 337a. When the identification information indicates “1”, the contrast value calculation section 333a outputs the calculated contrast value to the contrast value storage section 338. The contrast value storage section 338 stores the contrast value output from the contrast value calculation section 333a. When the identification information indicates “2”, the contrast value calculation section 333a outputs the calculated contrast value to the average value calculation section 339.

The average value calculation section 339 calculates the average value of the contrast value output from the contrast value calculation section 333a and the contrast value stored in the contrast value storage section 338. The average value calculation section 339 outputs the calculated average value to the focus target detection section 334. The focus target detection section 334 detects the focus target position from the average value of the contrast values output from the average value calculation section 339.

According to the second embodiment, occurrence of a bright spot within the image used to calculate the contrast value can be reduced by switching the illumination light (illumination condition), so that the contrast value can be stably calculated.

Although an example in which the average value of the contrast values calculated under different illumination conditions is used to detect the focus target position has been described above, another configuration may also be employed. For example, the maximum value among a plurality of contrast values may be detected, and may be used to detect the focus target position. Although an example in which two pairs of illumination sources and illumination lenses are used has been described above, another configuration may also be employed. For example, three or more pairs of illumination sources and illumination lenses may be used.

According to the second embodiment, the focus control section (AF control section 330) includes the bright spot-suppressing section 337a that controls the imaging condition so as to suppress occurrence of a bright spot within the focus detection image (see FIG. 14).

Specifically, the bright spot-suppressing section 337a suppresses occurrence of a bright spot within the focus detection image by switching an illumination light source that illuminates the object between a plurality of illumination light sources (white light sources 270 and 271). As shown in FIGS. 12 and 13, the focus control section acquires a plurality of focus detection images at a single position of in-focus object plane. The bright spot-suppressing section 337a causes the bright spot suppression condition to differ corresponding to each of the plurality of focus detection images by switching the illumination light source between the plurality of illumination light sources.

More specifically, the direction of the image captured by the imaging section 200 opposite to a first direction D1 is referred to as a second direction D2 (see FIG. 10). In this case, the bright spot-suppressing section 337a causes first illumination light to be applied to the object from the side in the first direction D1 (causes the white light source 270 to be turned ON) when a first image is captured by the imaging section 200 (see FIGS. 11 and 12). The bright spot-suppressing section 337a causes second illumination light to be applied to the object from the side in the second direction D2 (causes the white light source 271 to be turned ON) when a second image is captured by the imaging section 200 (see FIG. 13). As shown in FIGS. 15 and 16, the focus control section sets an area of the first image on the side in the second direction D2 to be a first focus detection image, and sets an area of the second image on the side in the first direction D1 to be a second focus detection image. The focus control section performs the focus control process based on the first focus detection image and the second focus detection image.

An area for which occurrence of a bright spot is suppressed can be obtained by thus changing the emission position of the illumination light. The effects of a bright spot on the contrast value can be reduced by calculating the contrast value of the area for which occurrence of a bright spot is suppressed.

### 4. Third Embodiment

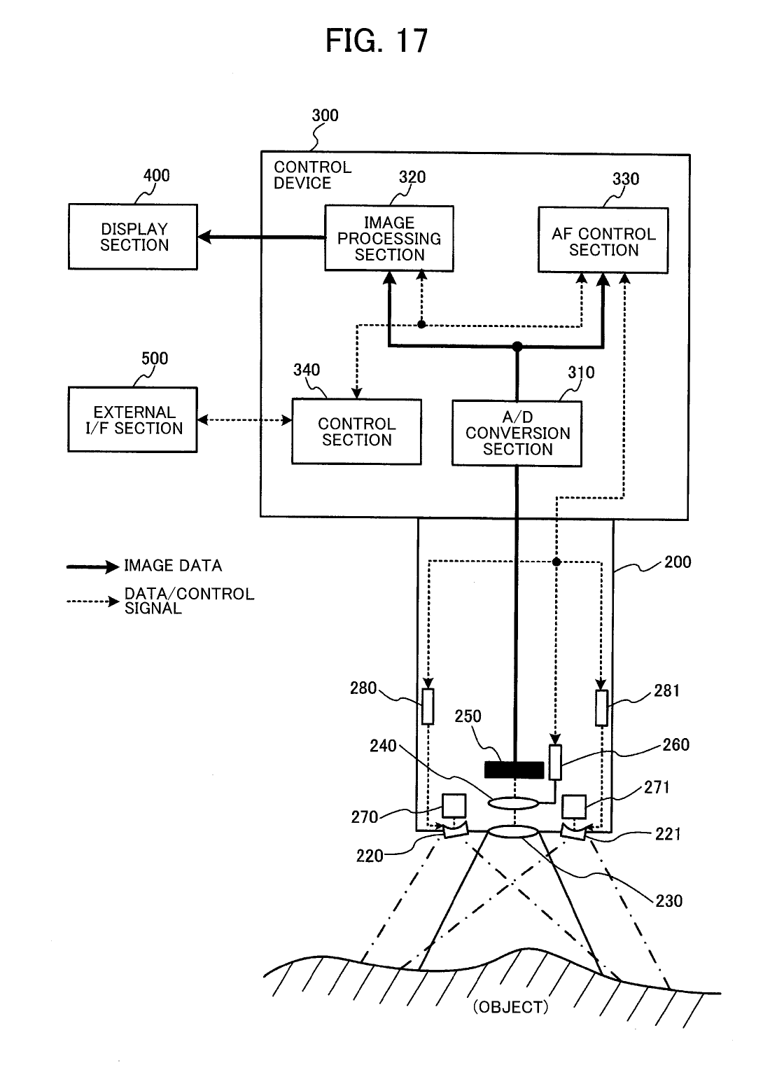

A third embodiment of the invention is described below. In the third embodiment, occurrence of a bright spot is suppressed by changing the irradiation direction of illumination light. FIG. 17 shows a third configuration example of an endoscope system. The endoscope system includes an imaging section 200, a control device 300, a display section 400, and an external I/F section 500. Note that description of the same elements as those described above in connection with the first embodiment is appropriately omitted.

The imaging section 200 includes an LED or the like. The imaging section 200 includes two white light sources 270 and 271 (a plurality of white light sources in a broad sense) that emit white light. The imaging section 200 also includes illumination lenses 220 and 221 that focus white light, and apply the white light to the observation target, and irradiation angle change sections 280 and 281 that adjust the irradiation angle of the illumination lenses 220 and 221. The imaging section 200 further includes an objective lens 230 that focuses light reflected by the observation target, a focus adjustment lens 240 that adjusts the in-focus object plane position, an imaging element 250 that detects the focused reflected light, and a focus driver section 260 that drives the focus adjustment lens 240.

The irradiation angle change sections 280 and 281 are connected to the AF control section 330, and change the angle of the illumination lenses 220 and 221 corresponding to a control signal from the AF control section 330. The details of the irradiation angle change sections 280 and 281 are described later.

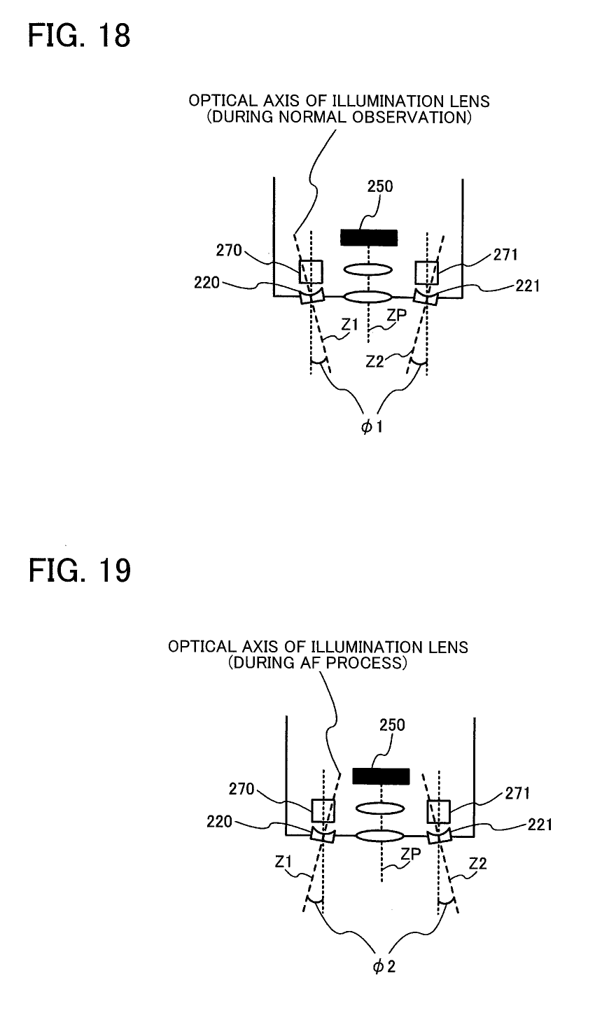

A method according to the third embodiment that stably calculates the contrast value is described below. As shown in FIG. 18, the angle of the illumination lenses 220 and 221 is set to “φ1” when the AF process is not performed. In this case, illumination light emitted through the illumination lenses 220 and 221 and specularly reflected light that occurs when the illumination light is specularly reflected by the surface of the object have a relationship shown in FIG. 9.

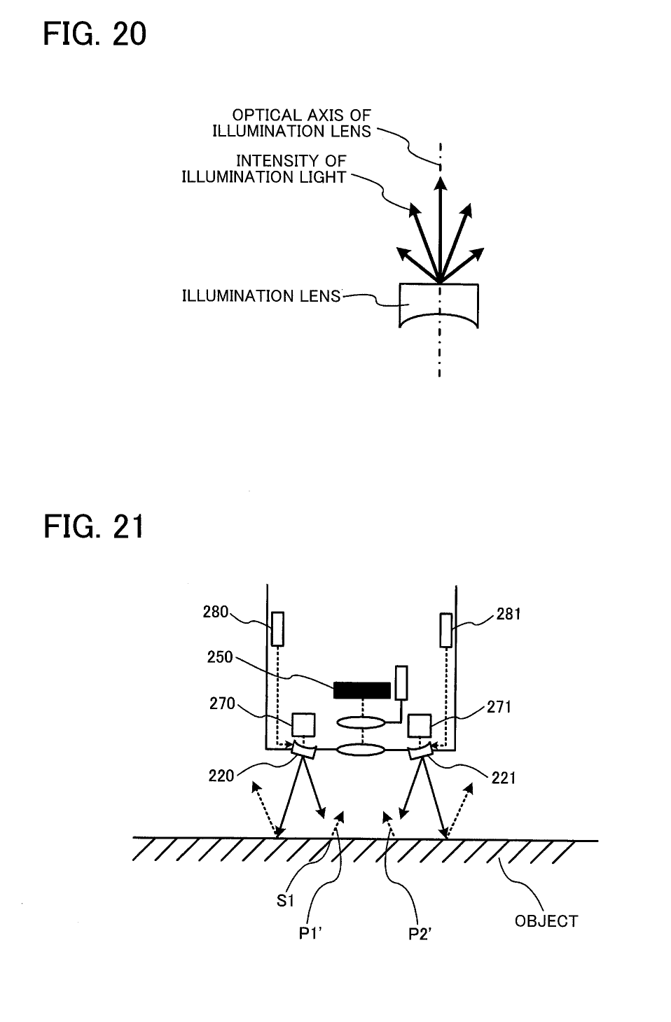

As shown in FIG. 19, the angle of the illumination lenses 220 and 221 is set to “φ2” when the AF process is performed. As shown in FIG. 20, the intensity of the illumination light emitted through each of the illumination lenses 220 and 221 becomes a maximum along the optical axis of the illumination lens, and tends to decrease as the angle formed by the illumination light and the optical axis of the illumination lens increases. In FIG. 20, the length of each arrow indicates the intensity of the illumination light. Therefore, when the angle of the illumination lenses 220 and 221 is set to “φ2”, the illumination light emitted through the illumination lenses 220 and 221 and specularly reflected light that occurs when the illumination light is specularly reflected by the surface of the object have a relationship shown in FIG. 21.

In FIG. 20, the angle formed by a straight line that connects a point S1 on the object and the illumination lens and the optical axis of the illumination lens is higher than that of FIG. 9. Therefore, the intensity of the illumination light that reaches the point S1 on the object when the angle of the illumination lenses 220 and 221 is set to “φ2” (FIG. 20) is relatively lower than the intensity of the illumination light that reaches the point S1 on the object when the angle of the illumination lenses 220 and 221 is set to “φ1” (FIG. 18). As a result, the intensity (amount) of the specularly reflected light that enters the imaging element 250 decreases, so that occurrence of a bright spot can be suppressed. This makes it possible to stably calculate the contrast value.

As shown in FIG. 18, the angle φ1 (φ2) is formed by the optical axis ZP of the imaging optical system and the optical axis Z1 or Z2 of the illumination lens 220 or 221. The angle φ2 is set so that the intensity (amount) of the specularly reflected light decreases as compared with the angle φ1. If an angle formed when the emission direction of the illumination light intersects the objective lens is referred to as a negative angle, the angle is set so that the relationship “φ2−φ1>0” is satisfied, for example. FIG. 18 shows an example in which φ1<0. Note that the angle φ1 may be equal to or greater than 0.

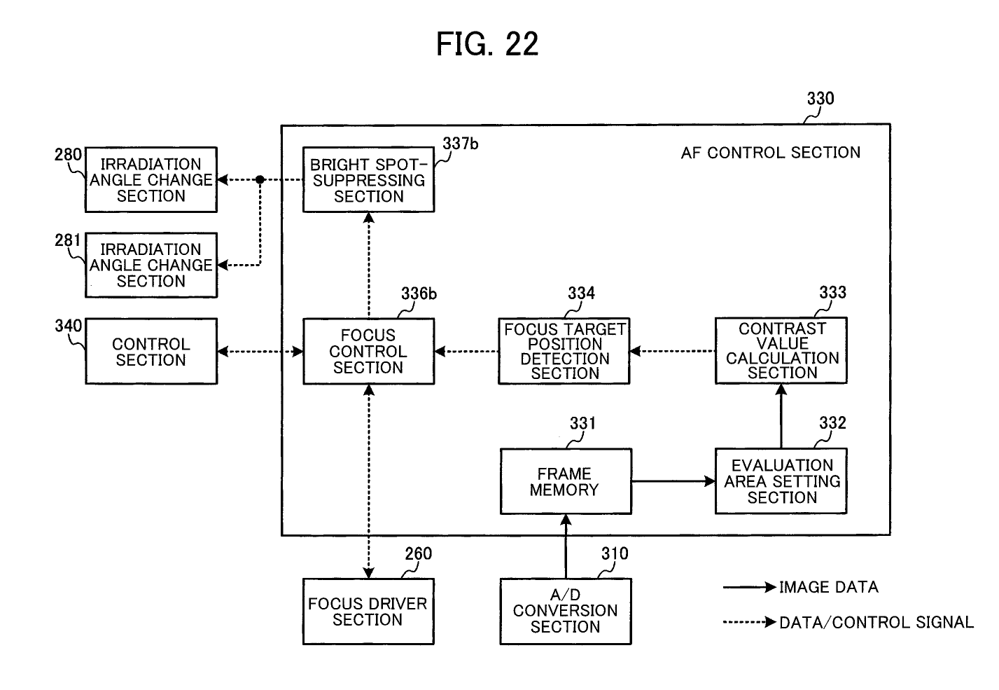

FIG. 22 shows a third detailed configuration example of the AF control section 330. The AF control section 330 includes a frame memory 331, an evaluation area setting section 332, a contrast value calculation section 333, a focus target detection section 334, a focus control section 336b, and a bright spot-suppressing section 337b. The configuration of the frame memory 331 and the processes performed by the evaluation area setting section 332, the contrast value calculation section 333, and the focus target detection section 334 are the same as those described above in connection with the first embodiment.

The focus control section 336b is bidirectionally connected to the control section 340. When the focus control section 336b has received AF start information from the control section 340, the focus control section 336b starts the AF process, and outputs bright spot suppression start information to the bright spot-suppressing section 337b.

The bright spot-suppressing section 337b outputs a control signal to the irradiation angle change sections 280 and 281 based on the bright spot suppression start information output from the focus control section 336b so that the irradiation angle change sections 280 and 281 change the angle of the illumination lenses. The irradiation angle change sections 280 and 281 change the angle of the illumination lenses to “φ1” or “φ2”, for example.

The angle of the illumination lenses is set to “φ1” when the AF process is not performed. The bright spot-suppressing section 337b outputs a trigger signal for changing the angle of the illumination lenses 220 and 221 to “φ2” to the irradiation angle change sections 280 and 281 based on the bright spot suppression start information output from the focus control section 336a. The irradiation angle change sections 280 and 281 change the angle of the illumination lenses 220 and 221 to “φ2” when the irradiation angle change sections 280 and 281 have received the trigger signal from the bright spot-suppressing section 337b.

The bright spot-suppressing section 337b outputs a trigger signal for changing the angle of the illumination lenses to “φ1” to the irradiation angle change sections 280 and 281 when bright spot suppression end information has been output from the focus control section 336a. The irradiation angle change sections 280 and 281 change the angle of the illumination lenses 220 and 221 to “φ1” when the irradiation angle change sections 280 and 281 have received the trigger signal from the bright spot-suppressing section 337b. The angle of the illumination lenses 220 and 221 is thus returned to the angle used when the AF process is not performed.

According to the third embodiment, the bright spot-suppressing section 337b suppresses occurrence of a bright spot within the focus detection image by controlling the emission direction (irradiation angle) of illumination light that illuminates the object (see FIG. 22).

Specifically, the bright spot-suppressing section 337b sets the emission direction of the illumination light that illuminates the object to a first emission direction (angle φ1) when the normal image is captured (see FIG. 18). The bright spot-suppressing section 337b sets the emission direction of the illumination light to a second emission direction (angle φ2) that differs from the first emission direction when the focus detection image is captured (see FIG. 19).

This makes it possible to acquire an image for which occurrence of a bright spot is suppressed by changing the emission direction of the illumination light, and reduce the effects of a bright spot on the contrast value by calculating the contrast value of the acquired image.

Note that the emission direction of the illumination light refers to a direction in which the intensity of the illumination light becomes a maximum (e.g., a direction along the optical axis of the illumination lens).

### 5. Fourth Embodiment

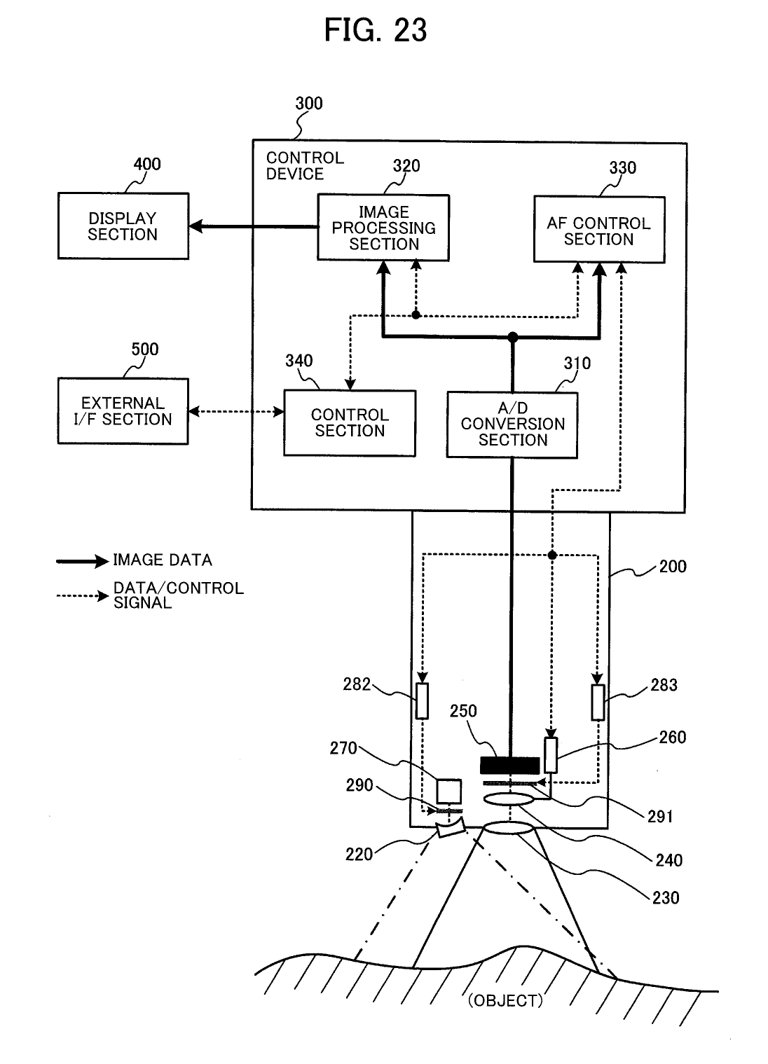

A fourth embodiment of the invention is described below. In the fourth embodiment, occurrence of a bright spot is suppressed by utilizing polarized light. FIG. 23 shows a fourth configuration example of an endoscope system. The endoscope system includes an imaging section 200, a control device 300, a display section 400, and an external I/F section 500. Note that description of the same elements as those described above in connection with the first embodiment is appropriately omitted.

The imaging section 200 includes a white light source 270 that emits white light, an illumination lens 220 that focuses the white light, and applies the white light to the observation target, and an objective lens 230 that focuses reflected light from the observation target. The imaging section 200 also includes a focus adjustment lens 240 that adjusts the in-focus object plane position, an imaging element 250 that detects the focused reflected light, and a focus driver section 260 that drives the focus adjustment lens 240. The configurations of the focus adjustment lens 240 and the imaging element 250 are the same as described above in connection with the first embodiment.

The imaging section 200 is configured so that a polarizing filter 290 can be inserted into the optical path between the white light source 270 and the illumination lens 220, and a polarizing filter 291 can be inserted into the optical path between the focus adjustment lens 240 and the imaging element 250.

The polarizing filter 290 is connected to a polarizing filter driver section 282, and the polarizing filter 291 is connected to a polarizing filter driver section 283. The polarizing filter driver sections 282 and 283 are connected to an AF control section 330 described later. The polarizing filter driver section 282 drives the polarizing filter 290 based on a control signal from the AF control section 330 so that the polarizing filter 290 is inserted into or removed from the optical path, and the polarizing filter driver section 283 drives the polarizing filter 291 based on a control signal from the AF control section 330 so that the polarizing filter 291 is inserted into or removed from the optical path. Each of the polarizing filters 290 and 291 is inserted into the optical path when the AF process is performed, and is removed from (i.e., is not inserted into) the optical path when the AF process is not performed.

The polarizing filter 290 allows only light that is emitted from the white light source 270 and vibrates (oscillates) in a specific direction to pass through, and the polarizing filter 291 allows only light that is emitted through the focus adjustment lens 240 and vibrates in a specific direction to pass through. The vibration (oscillation) direction of light that passes through the polarizing filter 290 is orthogonal to the vibration direction of light that passes through the polarizing filter 291. For example, the polarizing filter 290 allows vertically polarized light to pass through, and the polarizing filter 291 allows horizontally polarized light (first linearly polarized light) to pass through. When the polarizing filter 290 is inserted into the optical path between the white light source 270 and the illumination lens 220, vertically polarized light (second linearly polarized light) is emitted through the illumination lens 220.

The control device 300 includes an A/D conversion section 310, an image processing section 320, the AF control section 330, and a control section 340. The processes performed by the A/D conversion section 310, the image processing section 320, and the control section 340 are the same as those described above in connection with the first embodiment.

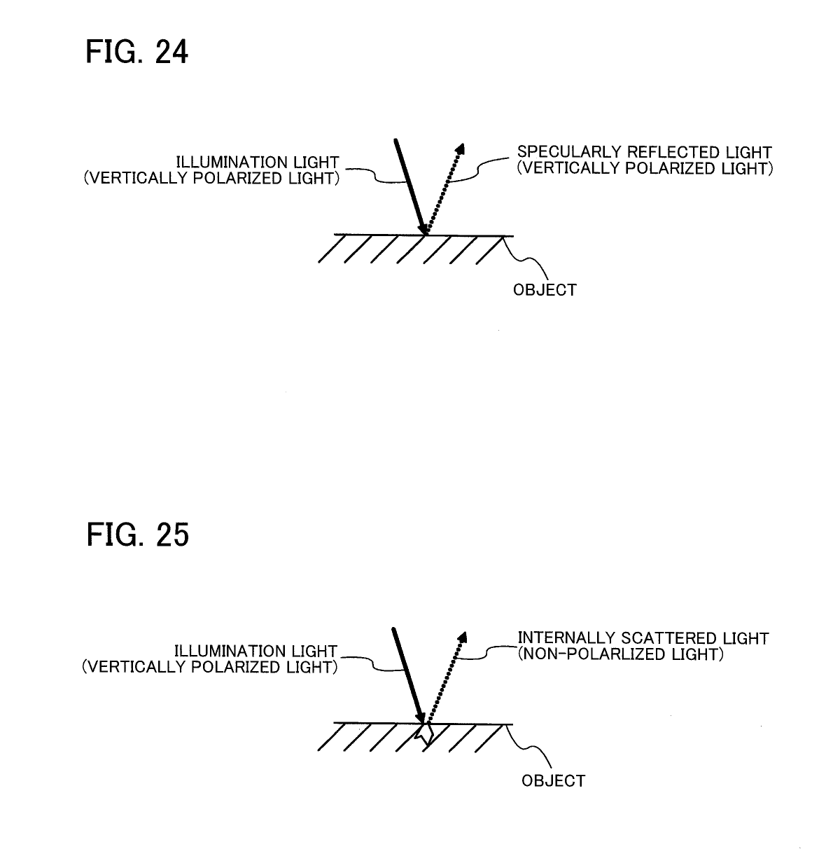

A method according to the fourth embodiment that suppresses occurrence of a bright spot is described below. When applying illumination light to an object, reflected light from the object is roughly classified into specularly reflected light and internally scattered light. The term “specularly reflected light” used herein refers to light that is obtained when the illumination light is reflected by the surface of the object (see FIG. 24) (e.g., light that has been specularly reflected by a wet surface (e.g., the mucous membrane of the digestive tract)). The term “internally scattered light” used herein refers to light that is obtained when the illumination light is scattered inside the object (see FIG. 25). A bright spot occurs within an image due to specularly reflected light.

As shown in FIG. 24, when the illumination light is vertically polarized light, the specularly reflected light is also vertically polarized light. As shown in FIG. 25, the internally scattered light is non-polarized light since the polarization state is lost due to scattering. Therefore, an image for which occurrence of a bright spot is suppressed can be acquired by applying vertically polarized illumination light to the object, and detecting reflected light from the object using the imaging element through a polarizing filter that allows only horizontally polarized light to pass through (i.e., blocks vertically polarized light).

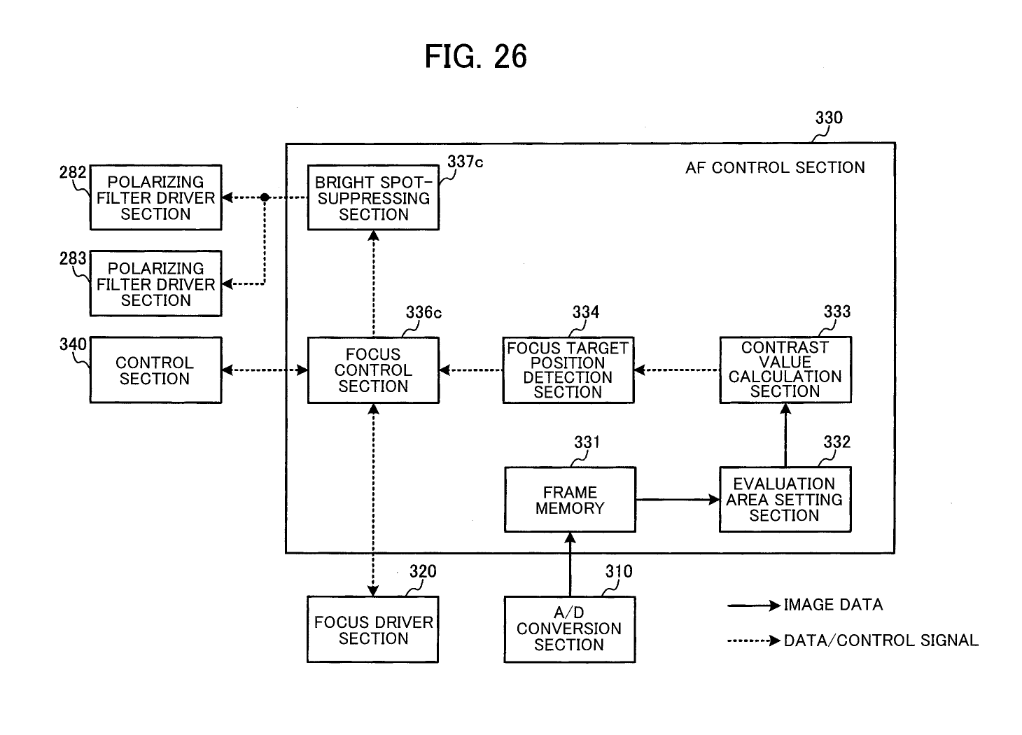

FIG. 26 shows a detailed configuration example of the AF control section 330.

The AF control section 330 includes a frame memory 331, an evaluation area setting section 332, a contrast value calculation section 333, a focus target detection section 334, a focus control section 336c, and a bright spot-suppressing section 337c. The configuration of the frame memory 331 and the processes performed by the evaluation area setting section 332, the contrast value calculation section 333, and the focus target detection section 334 are the same as those described above in connection with the first embodiment.

The focus control section 336c is bidirectionally connected to the control section 340. When the focus control section 336c has received AF start information from the control section 340, the focus control section 336c starts the AF process, and outputs bright spot suppression start information to the bright spot-suppressing section 337c.

When the bright spot-suppressing section 337c has received the bright spot suppression start information from the focus control section 336c, the bright spot-suppressing section 337c outputs a trigger signal to the polarizing filter driver sections 282 and 283, the trigger signal instructing the polarizing filter driver section 282 to insert the polarizing filter 290 into the optical path, and instructing the polarizing filter driver section 283 to insert the polarizing filter 291 into the optical path. The polarizing filter driver section 282 inserts the polarizing filter 290 into the optical path, and the polarizing filter driver section 283 inserts the polarizing filter 291 into the optical path when the trigger signal has been received from the bright spot-suppressing section 337c. As a result, the intensity (amount) of the specularly reflected light that enters the imaging element 250 decreases, so that occurrence of a bright spot can be suppressed. This makes it possible to stably calculate the contrast value.

When the bright spot-suppressing section 337c has received bright spot suppression end information from the focus control section 336c, the bright spot-suppressing section 337c outputs a trigger signal to the polarizing filter driver sections 282 and 283, the trigger signal instructing the polarizing filter driver section 282 to remove the polarizing filter 290 from the optical path, and instructing the polarizing filter driver section 283 to remove the polarizing filter 291 from the optical path. The polarizing filter driver section 282 removes the polarizing filter 290 from the optical path, and the polarizing filter driver section 283 removes the polarizing filter 291 from the optical path when the trigger signal has been received from the bright spot-suppressing section 337c.

According to the fourth embodiment, the bright spot-suppressing section 337c suppresses occurrence of a bright spot within the focus detection image by controlling the polarization condition for the image of the object captured by the imaging section 200 (see FIG. 26).

Specifically, the imaging section 200 includes the objective lens 230, the imaging element 250, and the polarizing filter 291 that allows the first linearly polarized light to pass through (see FIG. 23). The bright spot-suppressing section 337c causes the polarizing filter 291 to be inserted between the objective lens 230 and the imaging element 250 when the focus detection image is captured. The bright spot-suppressing section 337c causes the polarizing filter 291 not to be inserted between the objective lens 230 and the imaging element 250 when the normal image is captured.

The imaging section 200 also includes the illumination lens 220, and the second polarizing filter 290 that allows the second linearly polarized light to pass through, the polarization direction of the second linearly polarized light being orthogonal to the polarization direction of the first linearly polarized light. The bright spot-suppressing section 337c causes the second polarizing filter 290 to be inserted between the white light source 270 and the illumination lens 220 when the focus detection image is captured. The bright spot-suppressing section 337c causes the second polarizing filter 290 not to be inserted between the white light source 270 and the illumination lens 220 when the normal image is captured.

This makes it possible to acquire an image for which occurrence of a bright spot is suppressed by selectively inserting the polarizing filter, and reduce the effects of a bright spot on the contrast value by calculating the contrast value of the acquired image.

Although an example in which the polarizing filter is selectively inserted into the optical path has been described above, another configuration may also be employed. For example, the polarizing filter may also be inserted into the optical path when the AF process is not performed. In this case, it is also possible to acquire an image for which occurrence of a bright spot is suppressed when the AF process is not performed. This makes it possible to improve the visibility of the object since the number (or area) of bright spots in the display image can be reduced.

### 6. Fifth Embodiment

A fifth embodiment of the invention is described below. In the fifth embodiment, occurrence of a bright spot is suppressed by controlling the frame rate. An endoscope system according to the fifth embodiment includes a light source section 100, an imaging section 200, a control device 300, a display section 400, and an external I/F section 500. Note that description of the same elements as those described above in connection with the first embodiment is appropriately omitted.

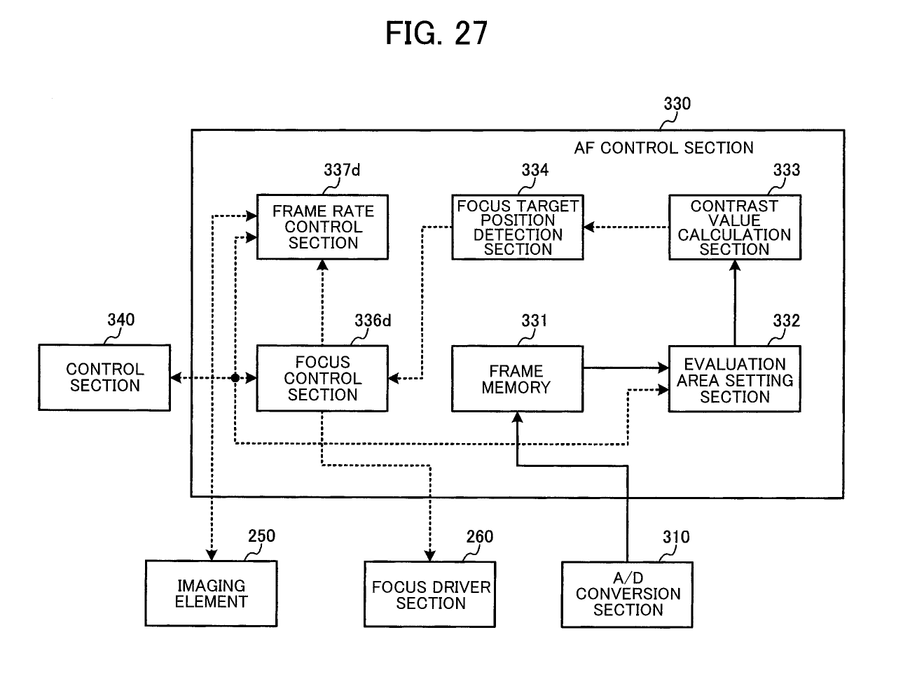

FIG. 27 shows a fifth detailed configuration example of the AF control section 330. The AF control section 330 includes a frame memory 331, an evaluation area setting section 332, a contrast value calculation section 333, a focus target detection section 334, a focus control section 336d, and a frame rate control section 337d. The configuration of the frame memory 331 and the processes performed by the evaluation area setting section 332, the contrast value calculation section 333, and the focus target detection section 334 are the same as those described above in connection with the first embodiment.

The focus control section 336d is connected to the frame rate control section 337d. When the focus control section 336d has received AF start information from the control section 340, the focus control section 336d starts the AF process, and outputs frame rate control start information to the frame rate control section 337d.

The frame rate control section 337d is connected to the imaging element 250, and is bidirectionally connected to the control section 340. The frame rate control section 337d determines the frame rate based on the frame rate control start information to control the imaging element 250.

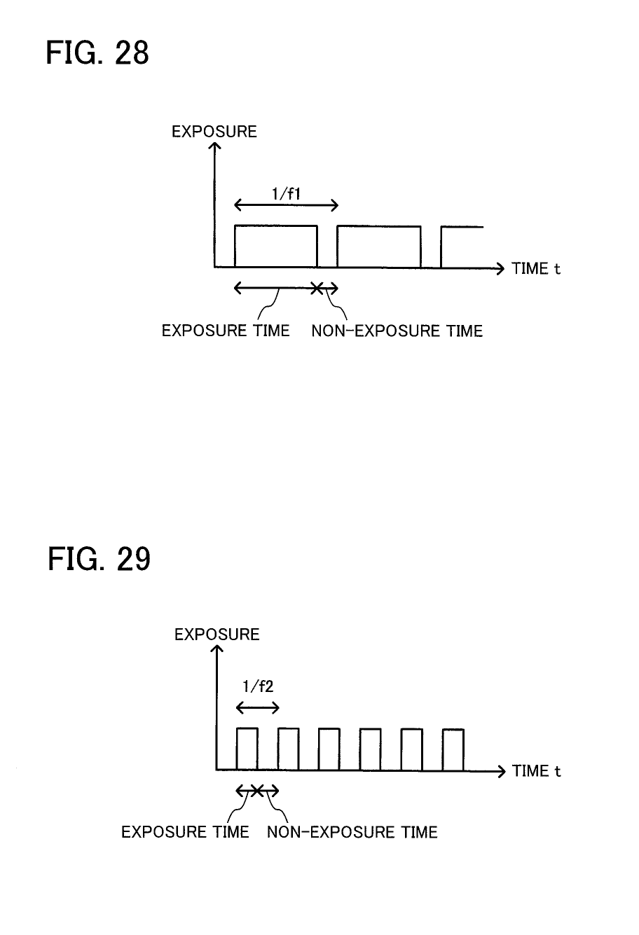

The control section 340 controls the imaging element 250 so that the imaging element 250 captures an image at a fixed frame rate f1 (frames per second (fps)) set in advance when the AF process is not performed. In this case, the time required to acquire one frame of the image is 1/f1 (s) (see FIG. 28). Note that the time required to acquire one frame of the image is the sum of the exposure time and the non-exposure time.

When the frame rate control section 337d has received the frame rate control start information, the frame rate control section 337d controls the imaging element 250 so that the imaging element 250 captures an image at a frame rate f2 (fps) used to calculate the contrast value. In this case, the time required to acquire one frame of the image is 1/f2 (s) (see FIG. 29). The frame rate f2 may be set in advance through the external I/F section 500 and the control section 340, for example.

The exposure time per frame of the image decreases as a result of setting the frame rate f2 to be higher than the frame rate f1, so that the exposure can be reduced. This makes it possible to suppress occurrence of a bright spot within the image used to calculate the contrast value, and stably calculate the contrast value. Moreover, the focus target position can be detected within a short time by increasing the frame rate when the AF process is performed.

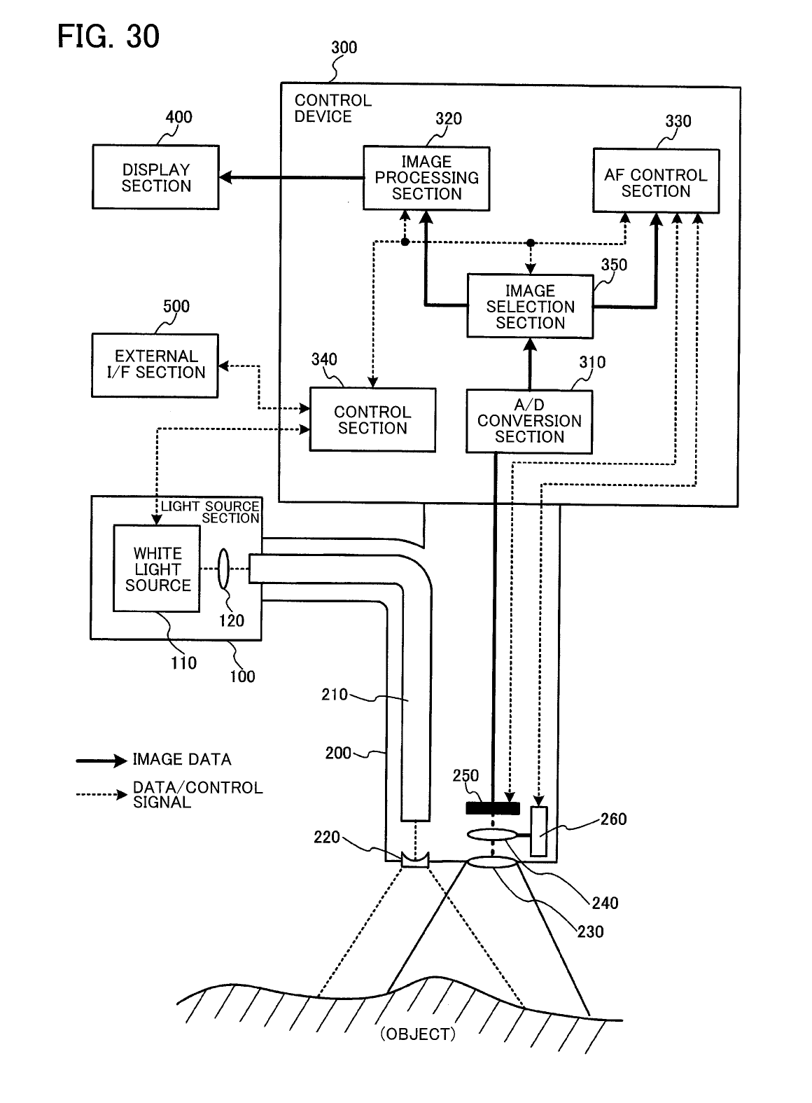

A modification of the fifth embodiment is described below. FIG. 30 shows a third modified configuration example of the endoscope system. The endoscope system includes the light source section 100, the imaging section 200, the control device 300, the display section 400, and the external I/F section 500. The control device 300 includes the A/D conversion section 310, the image processing section 320, the AF control section 330, the control section 340, and an image selection section 350.

In this modification, an image used to calculate the contrast value and a display image are sequentially acquired. Specifically, the A/D conversion section 310 converts an analog signal output from the imaging element 250 into a digital signal, and outputs the digital signal to the image selection section 350.

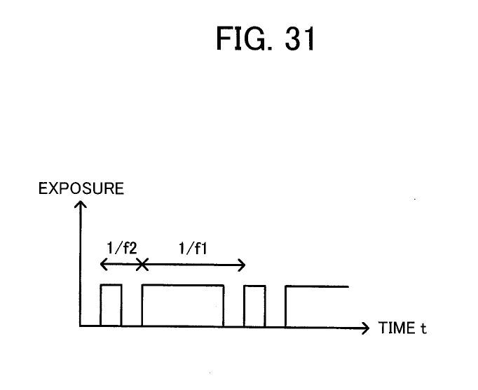

When the frame rate control section 337d has received the frame rate control start information, the frame rate control section 337d controls the imaging element 250 so that the imaging element 250 changes the image acquisition time every frame (see FIG. 31). An image acquired using the time 1/f1 (s) is used as the display image, and an image acquired using the time 1/f2 (s) is used as the image used to calculate the contrast value. The frame rate control section 337d outputs a control signal that indicates whether or not the acquired image is the display image to the control section 340.

The image selection section 350 receives the control signal that indicates whether or not the acquired image is the display image from the control section 340, and outputs the acquired image to the image processing section 320 when the acquired image is the display image. The image selection section 350 outputs the acquired image to the AF control section 330 as the image used to calculate the contrast value when the acquired image is not the display image.

Therefore, an image having a brightness equal to that achieved when the AF process is not performed can be displayed on the display section 400 when the AF process is performed. This makes it possible for the user to always observe the object, so that the operability and safety can be improved.

Although an example in which the frame rate is changed every frame has been described above, another configuration may also be employed. For example, the frame rate f2 (fps) used when the AF process is not performed may be successively used over a plurality of frames.

According to the fifth embodiment, the imaging condition is the frame rate. As shown in FIG. 27, the focus control section (AF control section 330) includes the frame rate control section 337d. As shown in FIGS. 28 and 29, the frame rate control section 337d sets the first frame rate f1 used when capturing the normal image and the second frame rate f2 used when capturing the focus detection image so that the first frame rate f1 and the second frame rate f2 differ from each other.

Specifically, the frame rate control section 337d sets the second frame rate f2 to be higher than the first frame rate f1.

As shown in FIG. 30, the control device includes a display control section (e.g., image processing section 320) that controls the display section 400. As shown in FIG. 31, the frame rate control section 337d may alternately set the frame rate to the first frame rate f1 and the second frame rate f2. The display control section causes the normal image captured at the first frame rate f1 to be displayed on the display section 400.

This makes it possible to acquire an image for which occurrence of a bright spot is suppressed by changing the frame rate, and reduce the effects of a bright spot on the contrast value by calculating the contrast value of the acquired image. Moreover, the display image can be captured and displayed when the AF process is performed by alternately setting the frame rate to the first frame rate f1 and the second frame rate f2.

### 7. Sixth Embodiment

A sixth embodiment of the invention is described below. In the sixth embodiment, an image for which occurrence of a bright spot is suppressed is acquired without changing the imaging condition irrespective of whether or not the AF process is performed. An endoscope system according to the sixth embodiment includes a light source section 100, an imaging section 200, a control device 300, a display section 400, and an external I/F section 500. Note that description of the same elements as those described above in connection with the first embodiment is appropriately omitted.

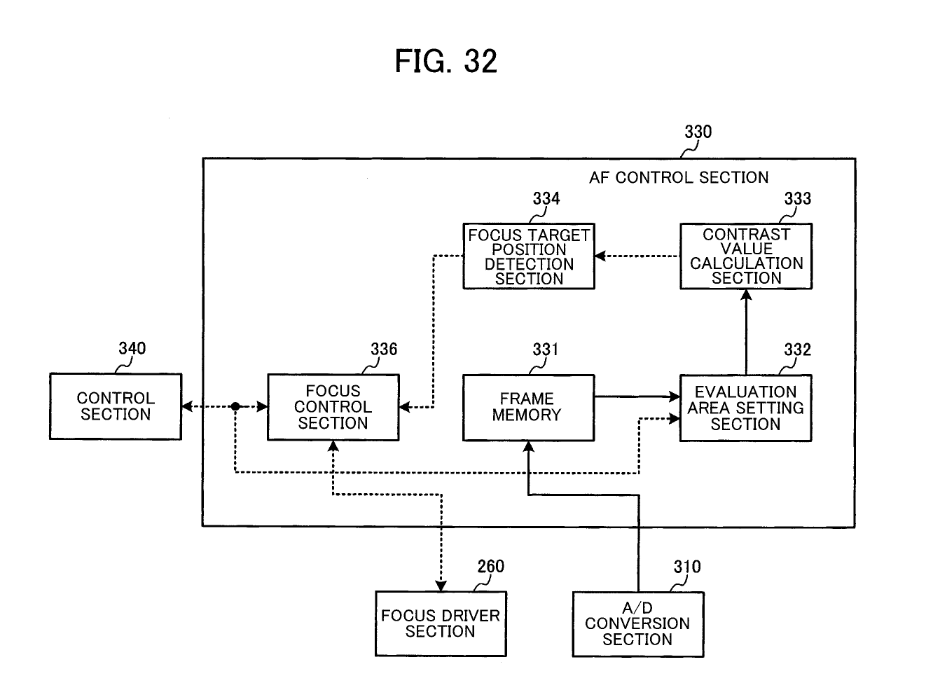

FIG. 32 shows a sixth detailed configuration example of the AF control section 330. The AF control section 330 includes a frame memory 331, an evaluation area setting section 332, a contrast value calculation section 333, a focus target detection section 334, and a focus control section 336.

A process according the sixth embodiment is described in detail below with reference to FIG. 33. As shown in FIG. 33, the number of bright spots and the bright spot occurrence area within an image acquired using an endoscope may change due to the motion (movement) of the object or the scope, and an image or an area in which the number (or area) of bright spots is relatively small may be obtained. In the sixth embodiment, an area in which the number (or area) of bright spots is small (or a bright spot is absent) is selected from the captured display image, and the contrast value is calculated using the selected area.

Specifically, the focus control section 336 sets the focus adjustment lens 240 to a first distance d1 (a first in-focus object plane position d1). A plurality of images F1 to F3 are captured at the distance d1, and stored in the frame memory 331. The evaluation area setting section 332 respectively sets evaluation areas EA1 to EA3 within the images F1 to F3 in an area in which the number (or area) of bright spots is small (or a bright spot is absent). For example, the evaluation area setting section 332 determines a pixel having a luminance value larger than a threshold value as a bright spot, and sets an area in which the number of pixels determined to be a bright spot is equal to or smaller than a threshold value to be the evaluation area. The contrast value calculation section 333 calculates the contrast value of each of the evaluation areas EA1 to EA3. For example, the contrast value calculation section 333 calculates the contrast value of each evaluation area by the HPF process, and determines the average value of the calculated contrast values to be the contrast value at the distance d1.

The focus control section 336 then sets the focus adjustment lens 240 to a second distance d2 (a second in-focus object plane position d2). A plurality of images F4 to F6 are captured at the distance d2. The evaluation area setting section 332 sets evaluation areas EA4 and EA5, and the contrast value calculation section 333 calculates the contrast value at the distance d2. The focus target detection section 334 detects the focus target position based on the contrast value calculated at each in-focus object plane position, and the focus control section 336 moves the focus adjustment lens 240 to the position at which the focus target position is achieved.

Although an example in which an area of each image in which the number (or area) of bright spots is small is selected has been described above, another configuration may also be employed. For example, an image in which the number (or area) of bright spots is a minimum may be selected from a plurality of images captured at an identical in-focus object plane position, and the contrast value may be calculated from the selected image. Although an example in which the in-focus object plane position is changed every given number of frames has been described above, another configuration may also be employed. For example, the number of bright spot pixels included in the captured image may be counted, the contrast value may be calculated from the captured image when the number of bright spot pixels included in the captured image is smaller than a threshold value, and the in-focus object plane position may then be changed.

According to the sixth embodiment, the image acquisition section (A/D conversion section 310) acquires a plurality of images F1 to F3 captured at a single in-focus object plane position (e.g., distance d1) (see FIG. 33). The focus control section (AF control section 330) acquires an image for which occurrence of a bright spot is suppressed from the plurality of images F1 to F3, and performs the focus control process using the acquired image as the focus detection image.

Specifically, the focus control section determines whether or not each pixel of each of the plurality of images F1 to F3 is a bright spot, respectively sets the evaluation areas EA1 to EA3 within the plurality of images F1 to F3 based on the determination results, and utilizes the images of the evaluation areas EA1 to EA3 as the focus detection images.

The focus control section may determine an image among the plurality of images F1 to F3 in which the number (or area) of bright spots is a minimum, and may utilize the image in which the number (or area) of bright spots is a minimum (e.g., image F3) as the focus detection image.

According to this feature, occurrence of a bright spot can be suppressed without changing the imaging condition by calculating the contrast value of an area or an image in which the number (or area) of bright spots is small. Moreover, the AF process can be performed while capturing the normal image since the imaging condition is not changed.

The embodiments according to the invention and the modifications thereof have been described above. Note that the invention is not limited to the above embodiments and the modifications thereof. Various modifications and variations may be made without departing from the scope of the invention. A plurality of elements disclosed in connection with the above embodiments and the modifications thereof may be appropriately combined. For example, some of the elements disclosed in connection with the above embodiments and the modifications thereof may be omitted. Some of the elements disclosed in connection with the above embodiments and the modifications thereof may be appropriately combined. Specifically, various modifications and applications are possible without materially departing from the novel teachings and advantages of the invention.

Any term (e.g., AF control section or contrast value) cited with a different term (e.g., focus control section or evaluation value) having a broader meaning or the same meaning at least once in the specification and the drawings may be replaced by the different term in any place in the specification and the drawings.

Although only some embodiments of the invention have been described in detail above, those skilled in the art would readily appreciate that many modifications are possible in the embodiments without materially departing from the novel teachings and advantages of the invention. Accordingly, such modifications are intended to be included within the scope of the invention.

What is claimed is:

1. A control device comprising:
an image acquisition section that acquires an image captured by an imaging section; and
a focus control section that performs a focus control process that focuses the imaging section on an object based on the acquired image,
the focus control section performing the focus control process based on an image for which occurrence of a bright spot is suppressed.

2. The control device as defined in claim 1,
the focus control section performing the focus control process using a focus detection image as the image for which occurrence of a bright spot is suppressed, the focus detection image being an image used for focus detection and being captured under an imaging condition that differs from an imaging condition used when capturing a normal image.

3. The control device as defined in claim 2,
the imaging condition being an exposure, and
the focus control section including an exposure control section that sets the exposure used when capturing the focus detection image to be smaller than the exposure used when capturing the normal image.

4. The control device as defined in claim 3,
the exposure control section controlling the exposure by controlling an intensity of illumination light that illuminates the object, and
the exposure control section setting the intensity used when capturing the focus detection image to be lower than the intensity used when capturing the normal image.

5. The control device as defined in claim 3,
the exposure control section controlling the exposure by controlling an exposure time when the imaging section captures an image, and
the exposure control section setting the exposure time used when capturing the focus detection image to be shorter than the exposure time used when capturing the normal image.

6. The control device as defined in claim 3,
the exposure control section controlling the exposure by controlling a transmittance of an objective optical system that is included in the imaging section, and
the exposure control section setting the transmittance used when capturing the focus detection image to be lower than the transmittance used when capturing the normal image.

7. The control device as defined in claim 2,
the focus control section including a bright spot-suppressing section that controls the imaging condition so as to suppress occurrence of a bright spot within the focus detection image.

8. The control device as defined in claim 7,
the bright spot-suppressing section suppressing occurrence of a bright spot within the focus detection image by switching an illumination light source that illuminates the object between a plurality of illumination light sources.

9. The control device as defined in claim 8,
the focus control section acquiring a plurality of the focus detection images at a single position of in-focus object plane, and
the bright spot-suppressing section causing a bright spot suppression condition to differ corresponding to each of the plurality of focus detection images by switching the illumination light source between the plurality of illumination light sources.

10. The control device as defined in claim 7,
the bright spot-suppressing section causing first illumination light to be applied to the object from a side in a first direction when a first image is captured by the imaging section, and causing second illumination light to be applied to the object from a side in a second direction when a second image is captured by the imaging section, the second direction and the first direction being directions of an image captured by the imaging section, the second direction being a direction opposite to the first direction, and
the focus control section setting an area of the first image on the side in the second direction to be a first focus detection image, setting an area of the second image on the side in the first direction to be a second focus detection image, and performing the focus control process based on the first focus detection image and the second focus detection image.

11. The control device as defined in claim 7,
the bright spot-suppressing section suppressing occurrence of a bright spot within the focus detection image by controlling an emission direction of illumination light that illuminates the object.

12. The control device as defined in claim 7,
the bright spot-suppressing section setting an emission direction of illumination light that illuminates the object to a first emission direction when the normal image is captured, and setting the emission direction of the illumination light to a second emission direction that differs from the first emission direction when the focus detection image is captured.

13. The control device as defined in claim 7,
the bright spot-suppressing section suppressing occurrence of a bright spot within the focus detection image by controlling a polarization condition for an image of the object captured by the imaging section.

14. The control device as defined in claim 7,
the imaging section including an objective lens, an imaging element, and a polarizing filter that allows linearly polarized light to pass through, and
the bright spot-suppressing section causing the polarizing filter to be inserted between the objective lens and the imaging element when the focus detection image is captured, and causing the polarizing filter not to be inserted between the objective lens and the imaging element when the normal image is captured.

15. The control device as defined in claim 14,
the imaging section including an illumination lens, and a second polarizing filter that allows second linearly polarized light to pass through, a polarization direction of the second linearly polarized light being orthogonal to a polarization direction of the linearly polarized light, and
the bright spot-suppressing section causing the second polarizing filter to be inserted between a light source and the illumination lens when the focus detection image is captured, and causing the second polarizing filter not to be inserted between the light source and the illumination lens when the normal image is captured.

16. The control device as defined in claim 2,
the imaging condition being a frame rate, and
the focus control section including a frame rate control section that sets a first frame rate used when capturing the normal image and a second frame rate used when capturing the focus detection image so that the first frame rate and the second frame rate differ from each other.

17. The control device as defined in claim 16,
the frame rate control section setting the second frame rate to be higher than the first frame rate.

18. The control device as defined in claim 16, further comprising:
a display control section that controls a display section,
the frame rate control section alternately setting the frame rate to the first frame rate and the second frame rate, and
the display control section causing the normal image captured at the first frame rate to be displayed on the display section.

19. The control device as defined in claim 1,
the imaging section including a polarizer that is provided between an objective lens and an imaging element, and allows linearly polarized light to pass through, and
the focus control section performing the focus control process based on an image obtained by capturing an image of the object that has passed through the polarizer.

20. The control device as defined in claim 19,
the imaging section including an illumination lens, and a second polarizing filter that is provided between the illumination lens and a light source, and allows second linearly polarized light to pass through, a polarization direction of the second linearly polarized light being orthogonal to a polarization direction of the linearly polarized light, and
the focus control section performing the focus control process based on an image obtained by capturing the object, illumination light that has passed through the second polarizing filter being applied to the object.

21. The control device as defined in claim 1,
the image acquisition section acquiring a plurality of images captured at a single position of in-focus object plane, and
the focus control section acquiring the image for which occurrence of a bright spot is suppressed from the plurality of images, and performing the focus control process using the acquired image as a focus detection image that is an image used for focus detection.

22. The control device as defined in claim 21,
the focus control section determining whether or not each pixel of each of the plurality of images is a bright spot, setting an evaluation area within each of the plurality of images based on results of the determination, and utilizing an image of the evaluation area as the focus detection image.

23. The control device as defined in claim 21,
the focus control section determining an image among the plurality of images in which a number or an area of bright spots is a minimum, and utilizing the image in which the number or the area of bright spots is a minimum as the focus detection image.

24. The control device as defined in claim 1,
the focus control section including a contrast value calculation section that calculates a contrast value of an evaluation area that is set within the acquired image, and performing the focus control process based on the calculated contrast value.

25. The control device as defined in claim 24,
the contrast value calculation section determining whether or not each of a plurality of pixels included in the evaluation area is a bright spot, and calculating the contrast value based on pixels among the plurality of pixels other than a pixel that has been determined to be the bright spot.

26. The control device as defined in claim 1,
the focus control section including a proper exposure determination section that determines whether or not an evaluation area is subjected to proper exposure, and
the focus control section performing the focus control process when the proper exposure determination section has determined that the evaluation area is subjected to proper exposure.

27. An endoscope apparatus comprising the control device as defined in claim 1.

28. A control device comprising:
an image acquisition section that acquires an image captured by an imaging section; and
a focus control section that performs a focus control process that focuses the imaging section on an object based on the acquired image,
the focus control section performing the focus control process based on a focus detection image, the focus detection image being captured under an imaging condition that differs from an imaging condition used when capturing a normal image.

29. An endoscope apparatus comprising the control device as defined in claim 28.

30. A focus control method comprising:
acquiring an image captured by an imaging section;
performing a focus control process that focuses the imaging section on an object based on the acquired image; and
performing the focus control process based on an image for which occurrence of a bright spot is suppressed.
